(19) United States
(12) Patent Application Publication
(10) Pub. No.: US 2010/0199346 A1
(43) Pub. Date: Aug. 5, 2010

(54) SYSTEM AND METHOD FOR DETERMINING SYMANTIC EQUIVALENCE BETWEEN ACCESS CONTROL LISTS

(75) Inventors: Yibei Ling, Belle Mead, NJ (US); Aditya Naidu, Edison, NJ (US); Rajesh Talpade, Madison, NJ (US)

Correspondence Address: TELCORDIA TECHNOLOGIES, INC., ONE TELCORDIA DRIVE 5G116, PISCATAWAY, NJ, 08854-4157, US

(73) Assignee: Telcordia Technologies, Inc., Piscataway, NJ (US)

(21) Appl. No.: 12/634,975

(22) Filed: Dec. 10, 2009

Related U.S. Application Data
(60) Provisional application No. 61/149,101, filed on Feb. 2, 2009.

(51) Int. Cl. G06F 9/32

(52) U.S. Cl. 726/12

(57) ABSTRACT

Aspects of the invention pertain to analyzing and modifying access control lists that are used in computer networks. Access control lists may have many individual rules that indicate whether information can be passed between certain devices in a computer network. The access control lists may include redundant or conflicting rules. An aspect of the invention determines whether two or more access control lists are equivalent or not. Order-dependent access control lists are converted into order-independent access control lists, which enable checking of semantic equivalence of different access control lists. Upon conversion to an order-independent access control list, lower-precedence rules in the order-free list are checked for overlap with a current higher precedence entry. If overlap exists, existing order-free rules are modified so that spinoff rules have no overlap with the current entry. This is done while maintaining semantic equivalence.

### CROSS-REFERENCE TO RELATED APPLICATION

The instant application claims the benefit of U.S. Provisional Patent Application No. 61/149,101, entitled “System and Method for Determining Semantic Equivalence Between Access Control Lists (ACL),” filed Feb. 2, 2009, the entire disclosure of which is hereby expressly incorporated by reference herein.

### BACKGROUND OF THE INVENTION

1. Field of the Invention

The invention generally relates to network security and network management. More particularly, aspects of the invention are directed to managing access control lists and traffic flow control in computer networks.

2. Description of Related Art

A computer network permits rapid exchange of information among various points or nodes in the network. User devices such as laptop computers, mobile phones and PDAs allow users to access content such as e-mail, videos, web pages, etc. User devices connect to other devices such as servers that provide the content.

Access may be limited to certain devices or a collection of nodes (e.g., specific IP addresses or ports). within the enterprise network or home. Information regarding permission or denial of access is maintained by a firewall and used to block or permit traffic flow accordingly. Depending on the size or complexity of the network and security policy, the access list control can be very difficult to manage and maintain.

An Access Control List (“ACL”) is a rule-based packet classifier. It plays an essential role in enterprise networks controlling traffic flow and for managing the network from intrusion and ensuring network security. ACLs are de facto order-dependent and multi-dimensional. Such properties have have many adverse effects. For instance, conflicts among rules may arise that impede security compliance analysis. And these properties make ACLs highly sensitive to change.

ACLs are one of the most important security features in managing access control and network security policies in large scale enterprise networks. An ACL contains a list of rules that define matching criteria inside packet header. Based on first matching rule criteria, each ACL is typically assumed to be a linear list of rules being executed from top down. For a give traffic flow, the action corresponding to the first rule that matches the condition takes effect. If no match is found, the router then drops the packet (implicit deny). When there are two or more rules matching a given criterion, based on first matching rule, the permit or deny classification of the first matching rule takes effect, whereas subsequent rules become irrelevant with respect to that traffic flow. If subsequent rules are irrelevant to all traffics, they are no-effect and hence become redundant.

The presence of no-effect rules further muddles the ability to comprehend the true semantic meaning of long ACLs, making ACL maintenance extremely difficult. Constant improvement in hardware/software capacity allows routers to handle more traffic flows, giving rise to an increased ACL size. In addition, a fine-granular control for traffic demands for an increased expressiveness of ACL language. This, in turn, further complicates the ability to comprehend the meaning of an ACL in total scope.

FIG. 1 illustrates a computer network 10 including a user computer 12 connected to a network router 14 via the Internet 16. A firewall 18 filters data packets send to or from computers coupled to the router 14. A first set of computers 20a and 20b behind the firewall 18 may be accessed via a first interface 22. And a second set of computers 24a, 24b and 24c may be accessed via a second interface 26.

Depending on ACL information maintained by the firewall 18, traffic flow may be permitted or denied. As shown, traffic may be permitted between the user computer 12 and the computer 24c coupled to second interface 26 as shown by arrow 28. In contrast, traffic from the user computer 12 to the computer 20a may be blocked by the firewall 18, as shown by the dashed arrow 30.

Resembling an if-then statement in the C programming language, the generic syntax of an ACL rule is typically expressed in the form of the if condition then action. The condition may specify source, destination IP address, protocol and port ranges. The action is binary, either permit or deny. While seemingly straightforward, in practice ACLs could be long, complex and error-prone. Furthermore, there may be hundreds or thousands of ACL rules implemented by multiple routers in a given network.

The complexity of ACLs is reflected in the growing demand for fine granular control of network traffic in the context of network security management and QoS requirements. Due to the order dependency, the intended meaning of every individual ACL rule can be altered or erased with removal of existing rules or addition of new rules. Such an excessive sensitivity to semantics of an ACL due to changes makes it extremely hard to comprehend the meaning of the ACL in total scope.

One area of particular interest is priority-based ACL implementations. In such implementations, each rule in a priority-based ACL will be assigned a priority. The priority value will be used to break a tie if a conflict among rules occur. Namely, among rules that match an incoming packet, the entry with the highest priority takes effect. A priority-based ACL is a generalization of a commonly-used ACL. It is flexible and adaptive in handling various QoS and security requirements.

Due to the practical significance in a large-scale network security management, the impact of ACLs has been an extensive research topic for many years. One type of method to address the ACL problem is to exploit fruitful theoretical results from the well-known Klee's measure problem. This is a computational geometry problem that is concerned with the efficiency of computing the measure of a union of multidimensional rectangular ranges. Klee provided an algorithm for computing the length of a union of intervals in one dimensional space and showed that time complexity of this algorithm is O(n log n).

It was subsequently shown by Fredman and Weide that Ω(n log n) is optimal in the linear decision tree model. Bentley considered the natural extension to d-dimensional cases, and showed that O(n log n) is also optimal for two dimensions (i.e., d=2). For d>2, the complexity generalizes to an upper bound of O(n^{d-1} log n). Overmars & Yap exploited the notion of trellis rectangles and used a generalization of the k-d tree to partition the plane into a collection of trellises. They proved that the upper bound of time complexity for computing the Klee's measure of n rectangles in the d-dimensional space is O(n^{d/2} log n).

Built on theoretical results from Overmars & Yap, Eppstein & Muthukrishnan proposed an algorithm based on the k-d tree for detecting conflicts in two-dimensional priority-based packet filters. A priority-based conflict refers to the presence of two filters with same priority level and different actions on the same packet. The computational complexity of the Eppstein & Muthukrishnan algorithm for determining whether a rule set contains any conflicts is O(n^{3/2}) where n is the size of rule set. This, however, is restricted to two dimensional packet classification and filter conflict detection problems.

Other work relates to routing performance in handling traffic, focusing primarily on designing data structures that support efficient packet classification while minimizing computational resource utilization in dynamic and static environments. For instance, a scheme has been proposed that performs a binary search on a prefix-length structured hash table. Others have given a detailed review of data structures for one-dimensional packet classification in routing tables, focused on longest-prefix matching and most-specific range matching tie breaker data structures.

A refined tie-breaker data structure has been proposed to support two-dimensional packet classification. A memory-efficient B-tree for one-dimensional packet classification has also been proposed. A variant of red-black tree data structures has been proposed for supporting three operations of longest-matching prefix-tables in O(n) where n is the number of (one-dimensional) rules.

### SUMMARY OF THE INVENTION

Systems and methods which analyze and manage access control list information are provided.

In accordance with an embodiment of the present invention, a method of processing access control lists in a computer network is provided. The method comprises obtaining a first access control list and storing it in memory; generating an order-free equivalent for the first access control list, the order-free equivalent comprising a plurality of multidimensional entries for permitting or denying access to resources in the computer network; and using the order-free equivalent to determine whether the first access control list is equivalent to a second access control list.

In one example, the first access control list includes a plurality of entries, and the method further comprises selecting first and second ones of the plurality of entries, the first entry having higher precedence in the first access control list than the second entry; determining whether the first entry completely encloses the second entry, and if the first entry complete encloses the second entry then the second entry is identified as being redundant, and if the first entry does not completely enclose the second entry then generating a spinoff of the second entry; storing any spinoffs of the second entry in memory; and repeating the selecting, the determining and the storing until all of the entries in the first access control list have been processed and the spinoffs form at least part of an order-free equivalent of the first access control list.

In one alternative, the method further comprises creating a modified access control list that omits all redundant entries. In another alternative, each spinoff includes at least one interval and a classification status. In this case, the at least one interval may represent at least one of an address or a port for the computer network. Alternatively, the at least one interval may include a selected interval of the first entry and a selected interval of the second entry, and the classification status is one of permit access or deny access.

In another example, the method further comprises determining a volume of the first access control list. Here, using the order-free equivalent to determine whether the first access control list is equivalent to the second access control list comprises comparing the volume of the first access control list to a volume of the second access control list to identify any semantic difference between the first and second access control lists. In one scenario, determining the volume is based on a permit or deny classification status for each access control list. In another scenario, determining the volume includes calculating a volume-based hash function of the order-free equivalent of the first access control list.

In another embodiment, an apparatus for processing access control lists in a computer network is provided. The apparatus comprises memory for storing information of a plurality of access control lists; and processor means for obtaining a first access control list from among a set of access control lists and storing it in the memory, for generating an order-free equivalent for the first access control list, the order-free equivalent comprising a plurality of multidimensional entries for permitting or denying access to resources in the computer network, and for using the order-free equivalent to determine whether the first access control list is equivalent to a second access control list.

In one example, the first access control list includes a plurality of entries, and the processor means is configured to select first and second ones of the plurality of entries, the first entry having higher precedence in the first access control list than the second entry; determine whether the first entry completely encloses the second entry, and if the first entry complete encloses the second entry then the second entry is identified as being redundant, and if the first entry does not completely enclose the second entry then generating a spinoff of the second entry; store any spinoffs of the second entry in the memory; and repeat the selecting, the determining and the storing until all of the entries in the first access control list have been processed and the spinoffs form at least part of an order-free equivalent of the first access control list.

In one alternative, the processor means is further configured to create a modified access control list that omits all redundant entries. In another alternative, each spinoff includes at least one interval and a classification status. In this case, the at least one interval may represent at least one of an address or a port for the computer network. Alternatively, the at least one interval may include a selected interval of the first entry and a selected interval of the second entry, and the classification status is one of permit access or deny access.

In a further example, the processor means is configured to determine a volume of the first access control list. The order-free equivalent is used to determine whether the first access control list is equivalent to the second access control list by comparing the volume of the first access control list to a volume of the second access control list to identify any semantic difference between the first and second access control lists. In this case, determining the volume may be based on a permit or deny classification status for each access control list. Or, alternatively, determining the volume may include calculating a volume-based hash function of the order-free equivalent of the first access control list.

Aspects of the invention are concerned with efficient determination of semantic equivalence between two firewalls (ALCs). This involves two processing steps: 1) for a given ACL, a recursive algorithm is used to convert the multidimensional order-dependent ACL into an order-free equivalent. All rules in the order-free equivalent are mutually independent. 2) Based on obtained order-free equivalents, the positive volumes of two order-free equivalents are computed. The identical positive volume of two equivalents form a necessary condition for the semantic equivalence of the two ACLs. Using this technique, we can efficiently determine whether two ACLs are semantically equivalent with a high probability.

### BRIEF DESCRIPTION OF THE DRAWINGS

FIG. 1 illustrates a computer network employing a firewall.

FIGS. 2(a)-(d) illustrate possible dependency situations in accordance with aspects of the invention.

FIG. 3 illustrates a flow diagram showing a process for constructing order-free equivalent ACLs in accordance with aspects of the invention.

FIGS. 4(a)-(b) illustrate a scenario for order-dependant and order-free ACLs in accordance with aspects of the invention.

FIGS. 5(a)-(f) illustrate d-box examples in accordance with aspects of the invention.

FIG. 6(a)-(f) illustrate 2-d box partitions in accordance with aspects of the present invention.

FIG. 7 illustrates a two-dimensional trellis for use with aspects of the present invention.

FIG. 8 illustrates equivalency between an order-dependent ACL and an order-free equivalent in accordance with aspects of the present invention.

FIG. 9 is a flow diagram illustrating a redundancy detection process in accordance with aspects of the present invention.

FIG. 11 illustrates ordering of ACL rules in accordance with aspects of the present invention.

FIGS. 12(a)-(b) illustrate the scope of rules in an ACL in accordance with aspects of the present invention.

FIGS. 13(a)-(b) illustrate ACL volume distribution in accordance use with aspects of the present invention.

FIG. 14 illustrates the ratio of redundant size to input size of extended ACLs in accordance with aspects of the present invention.

FIGS. 15(a)-(b) illustrate spinoff rule distributions in accordance with aspects of the invention.

FIG. 16 illustrates order dependent impact on ACL rules in accordance with aspects of the present invention.

FIG. 17 illustrates complexity variation in accordance with aspects of the present invention.

FIGS. 18(a)-(b) illustrate hash difference measures in accordance with aspects of the present invention.

FIG. 19 illustrates a distribution of order-dependent impact on individual ACL rules in accordance with aspects of the present invention.

FIG. 20 illustrates a computer network for use with aspects of the invention.

### DETAILED DESCRIPTION

Aspects, features and advantages of the invention will be appreciated when considered with reference to the following description of preferred embodiments and accompanying figures. The same reference numbers in different drawings may identify the same or similar elements. Furthermore, the following description is not limiting; the scope of the invention is defined by the appended claims and equivalents.

One aspect of the invention identifies an order-free equivalent for an order-dependent ACL. As used herein, the term “ordering” is generic, and is applicable to both the first-matching rule in commonly-used ACLs as well as priority-based ACLs. A theoretical framework has been developed that allows one to construct an order-free equivalent by recursively gluing together the projected results on each involved dimension, thereby overcoming inherent dimension-induced difficulty in ACL problems. This framework lays a basis for solving some fundamental key problems in ACLs, including automatic detection/resolution of redundant rules in an ACLs, determining whether given ACLs are semantic equivalents, quantitative evaluation of the impact of order-dependency on each ACL entry in an ACL, and quantitative metrics for quantifying the complexity of an ACL. In addition, the framework according to aspects of the invention can handle not only commonly-used ACLs (e.g., first-matching ACLs) but also priority-based ACLs.

In this section some related notions and definitions are introduced that will be used later on. The initial discussion focuses on standard ACLs (e.g., having a one dimensional range). While the focus in this section is on one dimensional range issues stemming from standard ACLs, it serves as an important step for understanding and handling the multidimensional problem in extended ACLs. The terms “order-independent” and “order-free” are used interchangeably herein. The terms “entry” and “rule” are also used interchangeably herein.

The notion of a “d-box” is first considered for simplified problem formulation. Definition 1: Let I₁, . . . , I_{d} be the intervals in 1, . . . , d^{th} dimensions. A d-box denoted by B^{d}, is defined as the Cartesian product of I₁, . . . , I_{d}, denoted as I_{I} [symbol] . . . [symbol] I_{d} or [I₁, . . . , I_{d}]. Let Iᵢ(B^{d})=Iᵢ denote the ith interval of B^{d}.

A d-box is also referred to as a d-dimensional rectangle. It can be seen that a 1-box is an interval (range) in one-dimensional space, and a 2-box is a rectangle in two-dimensional space that is formed by the Cartesian product of two 1-boxes from two orthogonal dimensions. Standard ACL syntax is employed to see how to map an ACL entry into one-dimensional range. It includes an action (permit or deny) and other traffic-related information. Thus:

access-list list-number {permit|deny} {host|source wildcard|any}

A standard ACL allows one to permit or deny traffic from source IP addresses specified by a pair of source IP address and source wildcard. Note that the access list number of a standard ACL ranges from 1 to 99, and is unique for a given device/router. A mapping between ACL terminology and range dimension ordering is given in the table below. For instance, the source address range is defined as I₁, the source port is defined as I₂, etc.

TABLE
ACL Terminology and Dimension Order

| | |
|---|---|
| source | destination |

| address | port | address | port | protocol | action |
|---|---|---|---|---|---|
| I₁ | I₂ | I₃ | I₄ | I₅ | S |
| [a_{L}, a_{R}] | [s_{L}, s_{R}] | [d_{L}, d_{R}] | [t_{L}, t_{R}] | [p_{L}, p_{R}] | 1/0 |

A standard ACL entry can be formulated as I₁ α S, where I₁=[a_{L},a_{R}] is a closed interval denoting the source address range and S denotes a classification action on the source address range (S=1/0 denotes the classification permit/deny action). Here, a_{L}=a_{R} means there is a single IP address.

A dotted decimal format IP address represented as d1.d2.d3.d4 can be uniquely converted to an integer form as Σᵢ₌₁⁴dᵢ 256⁴⁻ⁱ and vice versa. Let aᵢ be a standard ACL entry written as aᵢ=(I₁,S)ᵢ, where the subscript i denotes the ith entry in the original order in an ACL. Its source address range and traffic classification is denoted by I(aᵢ) and S(aᵢ). The intersection of aᵢ and aⱼ is defined as the one-dimensional range intersection I₁(aᵢ)∩I₁(aⱼ). Using the foregoing terminology, several important concepts are introduced as follows.

Definition 2: A standard ACL entry is said to be order independent if and only if (“iff”) the intersection of any two of its rules aᵢ, aⱼ, i≠j is empty, i.e., I₁(aᵢ)∩I₁(aⱼ)=0. A standard ACL is said to be order dependent iff there is exists a non-empty intersection of ACL rules aᵢ, aⱼ, i≠j, i.e., I₁(aᵢ)∩I₁(aⱼ)≠0.

Definition 3: The interval difference of I(aᵢ) and I(aⱼ), denoted by I(aᵢ)θI(aⱼ), is an interval set such that an interval x⊂I(aᵢ)θI(aⱼ) means x∩I(aᵢ)=x and x∩I(aⱼ)=0. The interval union of I(aᵢ) and I(aⱼ) is denoted by I(aᵢ)⊕I(aⱼ). For example, [1,10]θ[4,8]={[1,3],[9,10]}, [1,10]θ[4,15]={[1,3]}, and [1,10]⊕[14,15]={[1,10],[14,15]}.

Definition 4: Two standard ACLs A and B are said to be equivalent iff A⊂B and B⊂A. According to definition 4, for any given traffic from an arbitrary source address range that is denied and permitted by A, it will also be denied and permitted by B, and vice versa.

Thus, an ACL with n rules may be viewed as an ordered n-tuple as (a₁, a₂, . . . , aₙ), where aᵢ refers to the ith entry in the original order. Let aⱼπaᵢ denote that aᵢ precedes aⱼ in this ordered n-tuple, i.e., i<j. Due to the order dependency in ACLs, if aⱼπaᵢ, then the scope of aⱼ will be altered by aᵢ when I(aᵢ) and I(aⱼ) intersect.

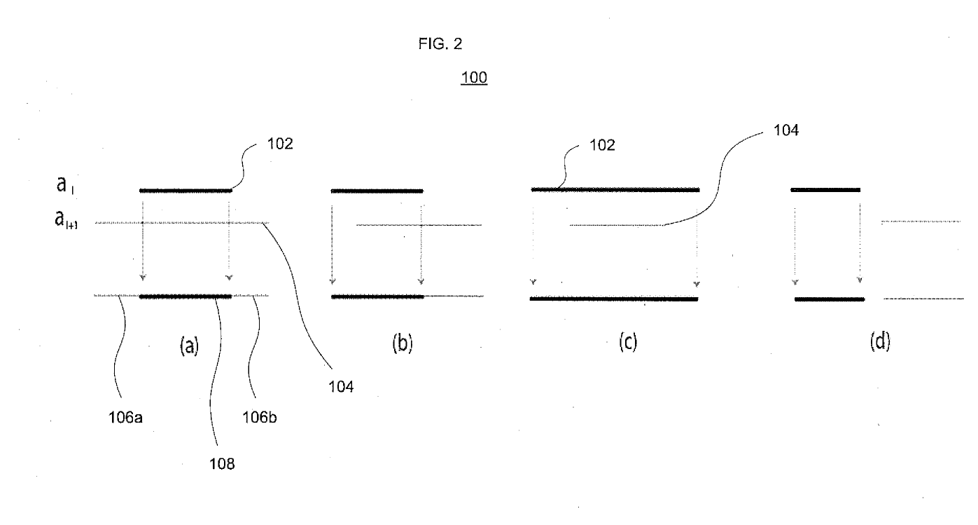

FIGS. 2(a)-(d) show a four-fold intersection classification 100 of entry pair aᵢ and aᵢ+1. FIG. 2(a) illustrates a “contain” scenario. FIG. 2(b) illustrates an “overlap” scenario. FIG. 2(c) illustrates an “enclose” scenario. And FIG. 2(d) illustrates a “disjoin” scenario. As shown, the interval presented by thick line 102 represents a deny interval of aᵢ. And the interval presented by the thin line 104 represents the permit interval of aᵢ+1. Due to the property of order dependency (aᵢ+1 π aᵢ), the classification scope of aᵢ is kept intact. Thus, how the scope of aᵢ+1 is affected depends on how the four-fold intersection classification with aᵢ. This is summarized as follows:

(I(aᵢ)∩I(aᵢ₊₁)≠I(aᵢ₊₁))∩(I(aᵢ)∩I(aᵢ₊₁)=I(aᵢ)) (1)

I(aᵢ)∩I(aᵢ₊₁)=I(aᵢ) (2)

(I(aᵢ)∩I(aⱼ)≠0)∩(I(aᵢ)∩I(aⱼ)≠I(aᵢ)∩(I(aᵢ)∩I(aⱼ)≠I(aⱼ)) (3)

I(aᵢ)∩I(aᵢ₊₁)=0 (4)

The contain relation in FIG. 2(a) satisfies equation (1). Due to the property of order dependency, this relation breaks down the scope of a₁₊₁ into two disjoint subintervals being sandwiched by the interval of aᵢ. The overlap relation in FIG. 2(b) meets equation (3). This relation results in a scope contraction of a₁₊₁. The enclose relation in FIG. 2(c) satisfies equation (2), which makes aᵢ₊₁ irrelevant to the execution of the ACL. The disjoin relation in FIG. 2(d) satisfies equation (4). Under this condition, the scope of both aᵢ and aᵢ₊₁ remains unaltered.

A similar analysis also can be applied to the case in which S(aᵢ)=S(aᵢ₊₁). For instance, the containment relation, as shown in FIG. 2(a), produces the two interval fragments 106a and 106b broken from the interval of aᵢ₊₁ plus one interval 108 from aᵢ. This observation suggests that the number of order-free rules may be reduced if two adjacent disjoint rules have disjoint rules have the same classification status.

For easy algebraic manipulation, one may define ∩I(aᵢ,aᵢ₊₁)≡I(aᵢ)∩I(aᵢ₊₁). The relations between aᵢ and a₁₊₁ (aᵢ₊₁ π aᵢ) in FIG. 2(a) is thus expressed in the union of two disjoint parts: 1) I(aᵢ); 2) I(aᵢ₊₁)θ∩I(aᵢ,aᵢ₊₁), which is equivalent to I(aᵢ₊₁)θI(aᵢ). It can readily be seen that I(aᵢ) and I(aᵢ₊₁)θ∩I(aᵢ,aᵢ₊₁) are disjoint since I(aᵢ)∩(I(aᵢ₊₁)θI(aᵢ))=0.

The notion of a “spinoff interval” is defined as follows. Definition 5: Let (I₁,I₂) be an ordered pair of intervals, V₁(I₁,I₂)≡I₂θ∩(I₁,I₂) be a spinoff interval set of I′₂, where the subscript refers to one-dimensional space. Let |V₁(I₁,I₂)| be the number of spinoff intervals (1-boxes) from interval I₂. With the different range assignments of aᵢ=(I,S)ᵢ and aᵢ₊₁=(I,S)ᵢ₊₁, the four-fold intersection classification of aᵢ and aᵢ₊₁, along with the spinoff interval (s) Vᵢ(I(aᵢ),I(aᵢ₊₁)) of I(aᵢ₊₁), is illustrated as below:

| Relation | I(aᵢ) | I(a_{i + 1}) | V₁(I(aᵢ), I(a_{i + 1})) |
|---|---|---|---|
| contain | [10, 15] | [5, 20] | [5, 9], [16, 20] |
| enclose | [5, 20] | [10, 15] | Ø |
| disjoin | [5, 10] | [15, 20] | [15, 20] |
| overlap | [10, 15] | [12, 20] | [16, 20] |

Corollary 1. For any given pair of aᵢ and aⱼ with aⱼ π aᵢ, V₁(I(aᵢ),I(aⱼ)) is unique, and max |V₁(I(aᵢ),I(aⱼ)|=2.

Spin-off rules of aᵢ₊₁ with respect to aᵢ are defined as follows:

(V₁(I(aᵢ),I(aᵢ₊₁)),S(aᵢ₊₁))≡(I,S(ai+1)|IεV₁(I(aᵢ),I(aᵢ₊₁)) (5)

The notion, of spinoff interval of an order pair of intervals can be extended immediately. Definition 6: Let I₁, . . . , Iₙ) be an ordered n-tuple of intervals, then a spinoff interval set of Iᵢ with respect to the ordered n-tuple of intervals, denoted by Iᵢ(I₁, . . . , Iᵢ), is:

$${I}_{i}^{′} ( {I}_{1} , … , {I}_{i} ) = \overbrace{(}^{{v}_{1}} {I}_{i} ⊖ {I}_{1} ) ⊖ … ⊖ {I}_{i - 1} ) \qquad ( 6 )$$

This equation can in turn be computed recursively as follows:

ν₁=V₁(I₁,Iᵢ), ν₂=V₁(I₂,ν₁), . . . , νᵢ₋₁=V₁(Iᵢ₋₁,νᵢ₋₂) (7)

where 2≦i≦n, I′ᵢ(I₁, . . . , Iᵢ)=νᵢ₋₁.

It follows from equation (7) that a step-by-step computation is required to determine spinoff interval sets I′ᵢ with respect to an ordered n-tuple of intervals. Spin-off rules of aⱼ may be further defined with respect to a₁, . . . , aⱼ₋₁ as follows:

$$( {I}_{j}^{′} ( I ( {a}_{1} ) , … , I ( {a}_{j - 1} ) , I ( {a}_{j} ) ) , S ( {a}_{j} ) ) ≡ ( \begin{matrix}\begin{matrix}I , S ( {a}_{j} ) \vert I ∈ \\ {I}_{j}^{′} ( \begin{matrix}I ( {a}_{1} ) , … , \\ I ( {a}_{j - 1} ) , \\ I ( {a}_{j} )\end{matrix} ) ,\end{matrix} \\ I ( {a}_{j} )\end{matrix} ) \qquad ( 8 )$$

An example of an ACL with five rules, together with spinoff rules, is given in the table below. A spinoff entry means an order-free entry after processing.

ACL Entries
α₁ = ([1, 3], 0) α₂ = ([2, 8], 1), α₃ = ([5, 10], 0),
α₄ = ([1, 10], 1), α₅ = ([20, 24], 0)
I'(α₂) = ν₁ = V₁(I(α₁), I(α₂)) = [4, 8]
${α}_{2} ' = ( I ' ( {α}_{2} ) , S ( {α}_{2} ) ) = ( [ 4 , 8 ] , 1 ) , D ( A , {α}_{2} ) = \frac{5}{7}$
ν₁ = V₁(I(α₁), I(α₃)) = [5, 10],
I'(α₃) = ν₂ = V₁(I(α₂),ν₁) = [9, 10]
${α}_{3} ' = ( I ' ( {α}_{3} ) , S ( {α}_{3} ) ) = ( [ 9 , 10 ] , 0 ] , D ( A , {α}_{3} ) = \frac{1}{3}$
ν₁ = V₁(I(α₁), I(α₄)) = [4, 10], ν₂ = V₁(I(α₂), ν₁) = [9, 10],
I′(α₄) = ν₃ = V₁(I(α₃), ν₂) =
α₄′ = 0, D(A, α₄) = 0
ν₁ = V₁(I(α₁), I(α₅)) = [20, 24], ν₂ = V₁(I(α₂), ν₁) = [20, 24],
ν₃ = V₁(I(α₃), ν₂) = [20, 24], I′(α₅) = V₁(I(α₄), ν₃) = [20, 24]
α₅′ = ([20, 24], 0), D(A, α₅) = 1

Thus, for a given aᵢ in ACL A, it can be seen that its spinoff interval I′(aᵢ) is a subset of its original interval I(aᵢ). The extent of scope contraction reflects the impact of order dependency of aᵢ on a₁, . . . , aᵢ₋₁. Such a dependency impact is defined as follows.

Definition 7: Let aᵢ be the ith entry in ACL A. The extent of order dependency of aᵢ on a₁, . . . , aᵢ₋₁, denoted by D(A,aᵢ), is defined as the ratio of the aᵢ's spinoff scope length to its original scope length. This is represented as:

$$D ( A , {a}_{i} ) = \frac{\vert {I}_{i}^{′} ( I ( {a}_{1} ) , I ( {a}_{2} ) , … , I ( {a}_{i} ) ) \vert}{\vert I ( {a}_{i} ) \vert} \qquad ( 9 )$$

This equation is a measure of scope contraction of aᵢ due to its order dependency on a₁, . . . , aᵢ₋₁. D(A,aᵢ)=1 means that aᵢ has no overlap with a₁, . . . , aᵢ₋₁, and D(A,aᵢ)=0 indicates that the scope of aᵢ is masked by a₁, . . . , aᵢ₋₁, and thus aᵢ is redundant. Between these two extreme scenarios, D(A,aᵢ) lies between (0,1). In view of this, a definition of ACL redundancy may be expressed as follows.

Definition 8: Let aⱼ be the kth entry in an ACL A. Then aₖ is said to be redundant iff D(A,aₖ)=0. It should be noted that a d-box in the context of standard ACL is a one-dimensional interval, and in extended ACLs it is a 5-dimensional rectangle. This definition goes beyond the pairwise redundant scenario and reflects the most likely scenario that aₖ is redundant because it could be jointly masked by more than one aⱼ (aₖ π aⱼ). For example, a₄ in the “ACL Rules” table is jointly masked by a triple of a₁,a₂,a₃. This makes the ACL redundant detection and resolution issue both challenging and interesting.

Lemma 1. Let aᵢ and aᵢ₊₁ be a pair of order dependent standard ACL rules. Then aᵢ, spinoff rules from aᵢ₊₁ (V₁(I(aᵢ),I(aᵢ₊₁))) are order-free and their union is equivalent to its order-dependent pair (a₁,aᵢ₊₁).

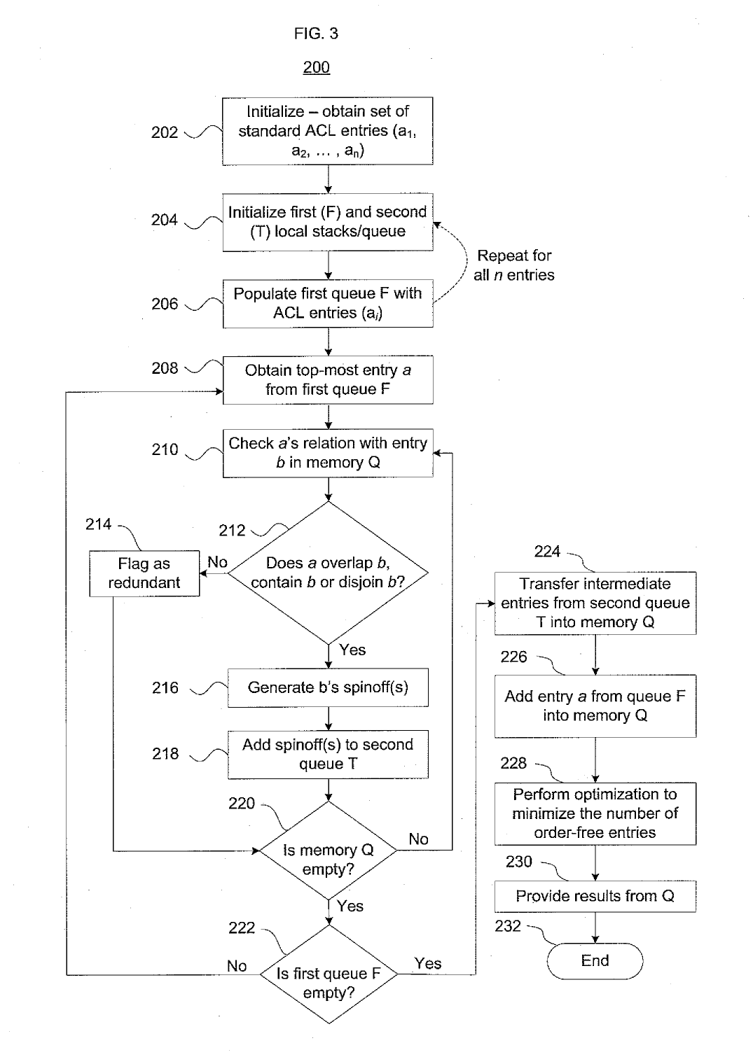

Thus, in accordance with one aspect of the invention, for an order-dependent standard ACL, there is a unique order-free equivalent ACL. This may be proven as follows. Let A be an order-dependent ACL (a₁,a₂, . . . , aₙ), and B its order-free equivalent, which is initially set to empty. Construction begins with removing aₙ from A and putting it as b₁ b₁ into B. Then, for each entry aᵢ removed from A, one may substitute every entry bₖεB with bₖ's spinoff rules (V₁(I(aᵢ),I(bₖ)),S(bₖ)), and then put aᵢ into B. This process is continued until A is empty. Lemma 1 and Corollary 1 set forth above ensure that B contains a unique order-free equivalent. A process 200 for converting an order dependent ACL into an order free equivalent is set forth in FIG. 3.

According to process 200, an entry higher in an ACL takes precedence over an entry which is lower. To reflect such a precedence ordering, a stack/queue (e.g., a LIFO queue) is created in which all the rules are pushed in sequentially with the highest one first. Then one entry is popped at a time. Because the latest popped entry has higher precedence ordering over all rules that have been popped so far, it is put in the order-free ACL being constructed as it is. All the other rules in the temporary order-free constructed so far are checked for any overlap with the latest one. If there is any overlap, the order-free rules constructed in previous steps are modified so that the spinoff rules have no overlap with the latest one, while at the same time maintaining the semantic equivalence.

Process 200 is explained as follows. The process is initialized at block 202, where a set of standard ACL rules (a₁, a₂, . . . , aₙ) are obtained, e.g., from a routers ACL list. A pair of local stacks or queues, e.g., a first queue “F” and a second queue “T” are initialized as shown at block 204. At block 206, the first queue F is populated with ACL rules aᵢ. This is repeated for all n rules.

As shown at block 208, the topmost entry a is obtained from the first queue F. Then, at block 210, a's relationship is checked with a first entry b in memory Q. In one example, memory Q is a LIFO stack.

All rules in Q are order-free with respect to the original rules processed so far. All rules in F are intact and in the original order. Each (original) rule in F (popped out in out in FILO fashion) needs to be compared with each rules in Q. If a rule popped out from F overlaps with a rule in Q, then the scope of the rule in Q needs to be modified so that the modified rule (which does not overlap with the rule in F) is then reinserted back to Q. Since rules in F precede rules in Q, when a rule popped out from F, it checks all rules in Q, and modifies the scope of rules if overlap occurs. After this check is completed, it is then inserted to Q. The process ends until F becomes empty, and then Q contains order-free rules (equivalents).

As shown in block 212, the process evaluates whether a overlaps b, contains b or is disjoint with b. Or does a enclose b. For instance, does aᵢ enclose aᵢ₊₁ such as is shown in FIG. 2C? If so, this signifies that b is redundant. In this case, the process proceeds to block 214 where b is flagged as redundant. If not, meaning that a either overlaps, contains or disjoins b, then the process proceeds to block 216. Here, one or more spinoffs of b are generated. For the case where the queue T is a LIFO queue, the spinoff may be created by putting the spinoff into T as follows: T.put((V₁(I(a),I(b)),S(b))). Then at block 218 these spinoffs are added to the second queue T.

The process then proceeds to block 220. Here, if the memory Q is not empty, e.g., one or more rules remain in a LIFO stack, the process returns to block 210, where a is evaluated against the next entry b. Otherwise, the process proceeds to block 222.

Here, if the first queue F is not empty, e.g., one or more a rules remain in a LIFO stack, then the process returns to block 208, where the next most recent entry a in the first queue F is obtained. Otherwise, the process proceeds to block 224. Here, any intermediate rules that are in the second queue T are transferred into memory Q. For instance, if second queue T is implemented as a stack-type storage memory, each entry is popped from the stack and placed in the memory Q, in the memory Q, which may also be a stack-type memory. This is done until the second queue T is empty. Then, as shown in block 226, entry a is added from first queue F into memory Q. Each entry preferably represents a single rule of an ACL. At block 228, optimization is performed to minimize the number of order-free rules. In one example, all rules may be sorted by the left endpoint in the interval in Q (O log(n) in running time). Adjacent rules having the same classification status may be merged as part of the minimization process. For instance, two rules aᵢ=(I₁,S)ᵢ and aⱼ=(I₁,S)ⱼ are said to be adjacent iff (a_{L})_{I}=(a_{R})ⱼ+1 or (a_{L})ⱼ=(a_{R})_{I}+1. The complexity of the merging process is known to be linear since Lemma 1 ensures that all (either intermediate or final) rules in Q are disjoint. The overall translation process can be carried out in O(n²), where n is the ACL size. Then, as shown in block 230, the results from Q—order-free equivalents—may be provided, e.g., to a user via a graphical user interface or stored electronically for later analysis. Then the process ends as shown at block 232.

In view of the above, one question of interest is for an order-dependent ACL with size of n, what is the size of the corresponding order-free ACL? The following lemma gives an upper bound on the size of order-free equivalent with respect to the size of order-dependent one.

Lemma 2. Let n be the size of order-dependent standard ACL, and k(n) be the size of its order-free equivalent. In this case, k(n)≦2n.

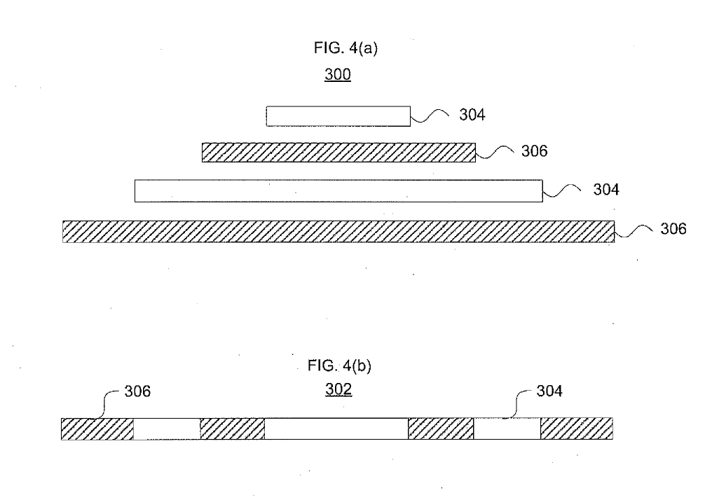

FIGS. 4(a)-(b) illustrate a worst-case scenario that maximizes the size of the order-free ACL. FIG. 4(a) denotes an order-dependent ACL 300 and FIG. 4(b) shows an order-free ACL 302. Here, the shaded bars 304 denote deny ranges and the unshaded bars 306 denote permit ranges. FIG. 4(a) denotes an order-dependent ACL 306 of size 4 while FIG. 4(b) shows the order-free ACL of size 7. This observation prompts a definition of ACL “complexity.”

Definition 9. Let n be the size of a non-redundant ACL A, and m be the size of its order-free ACL equivalent. Then the complexity of this ACL is m/n, denoted as ψ(A).

The rationale behind this definition may be explained as follows. The presence of redundant entries/rules is entirely irrelevant to the execution outcome of an ACL, and does not contribute to the complexity of the ACL. Therefore, such a redundancy should be excluded from complexity consideration. An order-free equivalent may be considered as a factored representation of its original ACL. Each order-free equivalent entry is a basic building block. Thus the number of basic building blocks is an attribute of the ACL. The function ψ(A) captures the essence of ACL complexity. It follows from lemma 2 and definition 9 that complexity of a standard ACL is bounded by a constant independent of the ACL's size, ranging between 1 and 2.

The next section focuses on extended ACLs, which can be formulated as a 5-dimensional range problem. Rather than dealing with this geometric problem in an ad hoc fashion, a general framework is provided that is applicable to an arbitrary number of dimensions.

An extended ACL entry according to aspects of the invention may be expressed as I₁ [symbol] I₂ [symbol] I₃ [symbol] I₄ [symbol] I₅ [symbol] S, where S is the image of the Cartesian product of its intervals in 5 orthogonal dimensions, denoted by (I₁, I₂, I₃, I₄, I₅, S) and S represents a binary action of permit or deny. For the ith entry in an extended ACL, it can be written as aᵢ=(I₁, I₂, I₃, I₄, I₅, S)ᵢ, and Iⱼ(aᵢ), 1≦j≦5 refers to the jth interval of a respectively.

The following table shows an example of a protocol range and port range number assignments based on an IP protocol specification. Notice that both top and udp are a point in the protocol dimension, and the IP protocol is in the full range of the protocol dimension. The port number range is given as is given as [0,65535].

TABLE
Protocol Range Assignment
IP [0:255]

| hopop | . . . | tcp | . . . | udp | . . . | reserved |
|---|---|---|---|---|---|---|
| [0, 0] | . . . | [6, 6] | . . . | [17, 17] | . . . | [255, 255] |

| | |
|---|---|
| Port operator operands | Port number |

| Symbol | lt | gt | eq | neq | range | Range |
|---|---|---|---|---|---|---|
| Meaning | < | > | = | ≠ | [,] | [0, 65535] |

The following example illustrates how to translate an extended ACL entry to its range representation:
access-list 101 permit udp 172.16.4.0 0.0.0.255 neq 120 172.16.3.0 0.0.0.255 neq 40
   This entry states that UDP traffic from source subnet 172.16.4.0/24 with a source port not equal to 120, destined to the destination subnet 172.16.3.0/24 with a destination port not equal (“neq”) to 40, is permitted (“permit”).

The next table presents a mapping between the different IP addresses, ports and traffic type in the ACL entry and their range representations.

TABLE
Extended ACL and Range Representation

| | |
|---|---|
| Extended ACL | Range Representation |

| source IP | mask | source IP address I₁ |
|---|---|---|
| 172.16.4.0 | 0.0.0.255 | [2886730752, 2886731008] |
| source port | | source port I₂ |
| neq 120 | | [0, 119], [121, 65535] |
| destination IP | mask | destination IP address I₃ |
| 172.16.3.0 | 0.0.0.255 | [2886730496, 2886730752] |

| | |
|---|---|
| destination port | port I₄ |
| neq 40 | [0, 39], [41, 65535] |
| Protocol | protocol I₅ |
| udp | [17, 17] |

The port number is in the range of [0,65535]. Thus, the neq 40 on the IP destination port is equivalent to two destination port ranges [0,39] and [39,65535]. In a similar manner, the neq 120 on source IP port is identical to two two source port ranges [0,119] and [121,65535]. Hence, this entry corresponds to four range representations specified below:

(I1,[0,119],I3,I4,[0,39],0)

(I1,[0,119],I3,I4,[41,65535],0)

(I1,[121,65535],I3,I4,[0,39],0)

(I1,[121,65535],I3,I4,[41,65535],0)

An extended ACL entry might yield different range representation rules, depending on the port operator operand being applied on both the source port and destination port. For an extended ACL with size of n, the size of its range representation is bounded by 4n. The notion of order dependency can be employed to extend an ACL as follows.

Definition 10. An extended ACL A is said to be order independent iff aᵢ, aⱼ, A, I j, there exists at least 1≦k≦d such that the intersection of the k-interval of aᵢ, and aⱼ i.e.,

$${∃}_{i \leq k \leq 5} {I}_{k} ( {a}_{i} ) ⋂ {I}_{k} ( {a}_{j} ) = 0.$$

A is order dependent iff the intersection of all k-intervals of aᵢ and aⱼ are non-empty, i.e.,

$${∀}_{1 \leq k \leq d} {I}_{k} ( {a}_{i} ) ⋂ {I}_{k} ( {a}_{j} ) \neq 0.$$

Given this, a d-box partition may be defined as follows.

Definition 11. A d-box partition of O⊂R^{d} is a set of nonempty d-boxes denoted {B₁^{d}, . . . , Bₖ^{d}} such that the union of Bᵢ's is equal to O and the intersection of Bᵢ^{d} and Bⱼ^{d} is empty for any distinct Bᵢ^{d} and Bⱼ^{d}.

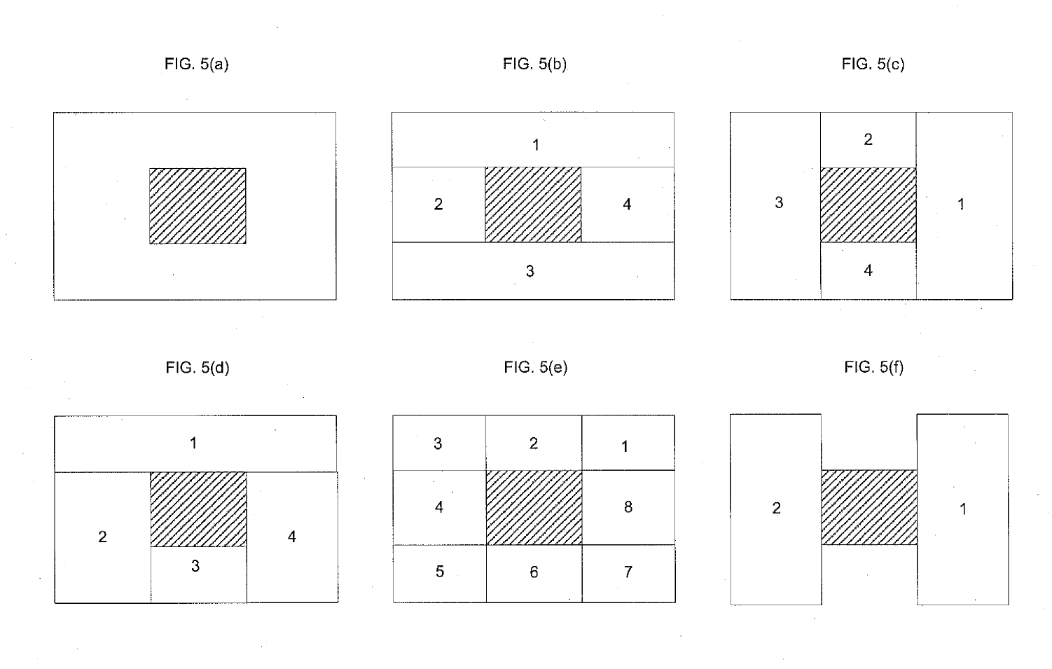

Consider the following example with regard to FIGS. 5(a)-(f). These figures depict an ACL containing two rules that intersect with one another. One entry, a₁, is represented by a shaded rectangle, while the other entry, a₂, is represented by an unshaded region.

Entry a₁ precedes entry a₂, and as a result, the scope of entry a₂ is altered (contracted) accordingly. Consequently, this is shown by a multiplicity of partitions. The altered/contracted areas are called spinoffs. The order dependent effect on entry a₂ is the ratio of the sum volume of spinoffs to the original volume. In the case shown in FIGS. 5(a)-(f), the sum volume of spinoffs is equal to the area (scope) of a₂ minus the area of a₁.

In one example, a₁=([4,7],[4,7],0) (shaded rectangle in FIG. 5(a)), and a₂=([1,10],[1,10],1) (unshaded rectangle in FIG. 5(a)) (a₂ π a₁). The 2-box of a₂ [1,10] [symbol] [1,10] minus the 2-box of a₁ [4,7] [symbol] [4,7] could yield many distinct d-box partitions. FIGS. 5(b)-(e) depict four 2-box partitions with different sizes. The d-box partitions in FIGS. 5(b)-(d) have the size of 4 while one shown in FIG. 5(e) has the size of 8. FIG. 5(f) clearly is not a d-box partition because there exists an unfilled area. Translation of an order dependent ACL into its order-free equivalent it tantamount to identifying a d-box partition. The following table compares an order-dependent ACL versus an order-free equivalent.

TABLE
order-dependent ACL versus an order-free equivalent
Order dependent entry pair (a₁, a₂)

| | |
|---|---|
| ([4, 7], [4, 7], 0) | ([1, 10], [1, 10], 1) |

Order-free equivalent

| | | |
|---|---|---|
| ([1, 3], [1, 10], 1) | ([8, 10], [1, 10], 1), 1) | ([4, 7], [1, 3], 1), |
| ([4, 7], [8, 10], 1) | ([4, 7], [4, 7], 0) | |

However, there are several difficulties in extended ACLs. For instance, translation of an order-dependent ACL to an order-free equivalent is not unique for a multi-dimensional case because the number of possibilities grows exponentially with the dimensionality. And order independency does not necessarily mean semantic equivalency, as shown by the incomplete partition case of FIG. 5(f).

In order to develop a proper framework and procedure for determining an order-free equivalent partition, the Vₖ( ) function is introduced as follows. Let A^{d}=(I₁, . . . , I_{d})ₐ and B^{d}=(I₁, . . . , I_{d})_{b} be two d-boxes, Iᵢ(A^{d}) be the ith closed interval of the A^{k} box, and [symbol] ᵢ₌₁^{k}Iᵢ(A^{d}) [symbol] I₁(A^{d}) [symbol] . . . [symbol] Iₖ(A^{d}), where 1≦k≦d, which is a k-dimensional projection of A^{d}. It can be seen that [symbol] ᵢ₌₁^{d}Iᵢ(A^{d})≡A^{d}. Let ∩Iᵢ(A^{d},B^{d})≡Iᵢ(A^{d})∩Iᵢ(B^{d}) be the ith intersecting interval of A^{d} and B^{d}.

Definition 12. Let A^{d} and B^{d} be two d-boxes. The function Vₖ(A^{d},B^{d}) is defined as:

$${V}_{k} ( {A}^{d} , {B}^{d} ) = {{⊗}^{k}}_{i = 1} {I}_{i} ( {B}^{d} ) ⊖ {{⊗}^{k}}_{i = 1} ⋂ {I}_{1} ( {A}^{d} , {B}^{d} ) \qquad ( 10 )$$

Vₖ(A^{d}, B^{d}) is referred to as a k-dimension projection of B^{d} minus a k-dimension projection of the intersection of A^{d} and B^{d}. Vₖ( ) is clearly not symmetrical. Let |Vₖ(A^{d}, B^{d})| denote the volume of Vₖ(A^{d},B^{d}), which can be expressed as follows.

$$\vert {V}_{k} ( {A}^{d} , {B}^{d} ) \vert = {\prod }_{i = 1}^{k} \vert {I}_{i} ( {B}^{d} ) \vert - {\prod }_{i = 1}^{k} \vert ⋂ {I}_{i} ( {A}^{d} , {B}^{d} ) \vert \qquad ( 11 )$$

This equation states that the volume of Vₖ(A^{d},B^{d}) equals the k-dimensional projection volume of B^{d} subtracted by the k-dimensional projection volume of the intersection of A^{d} and B^{d}. It should be noted that the Vₖ function is a multidimensional extension to the V₁ function set forth above.

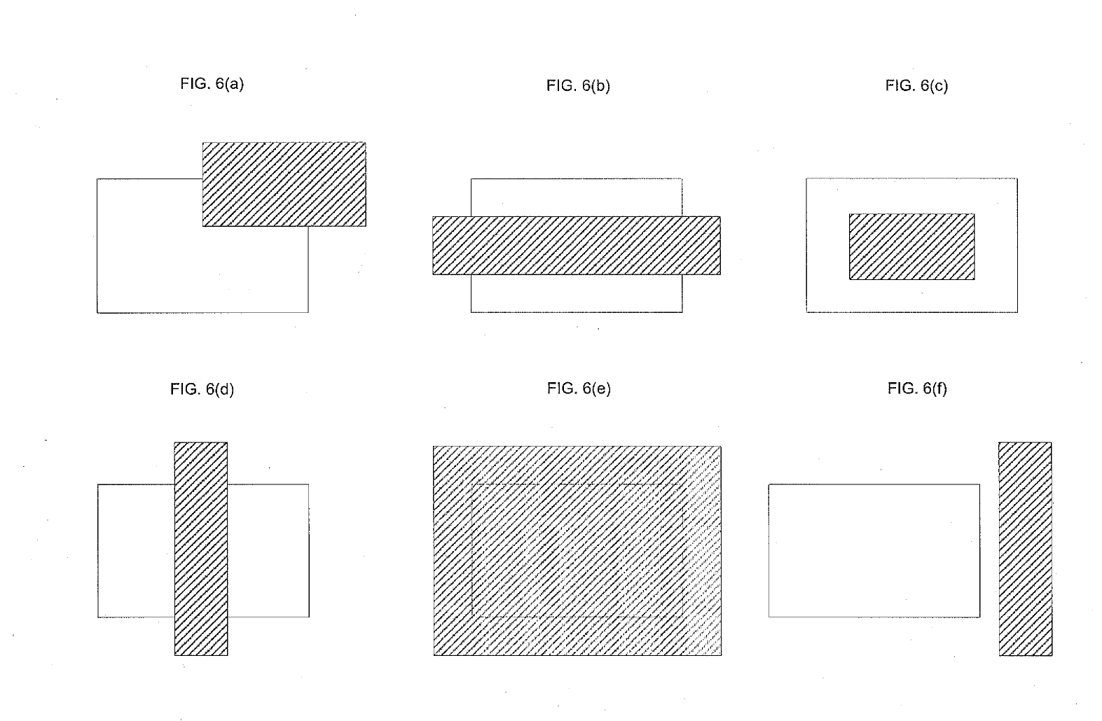

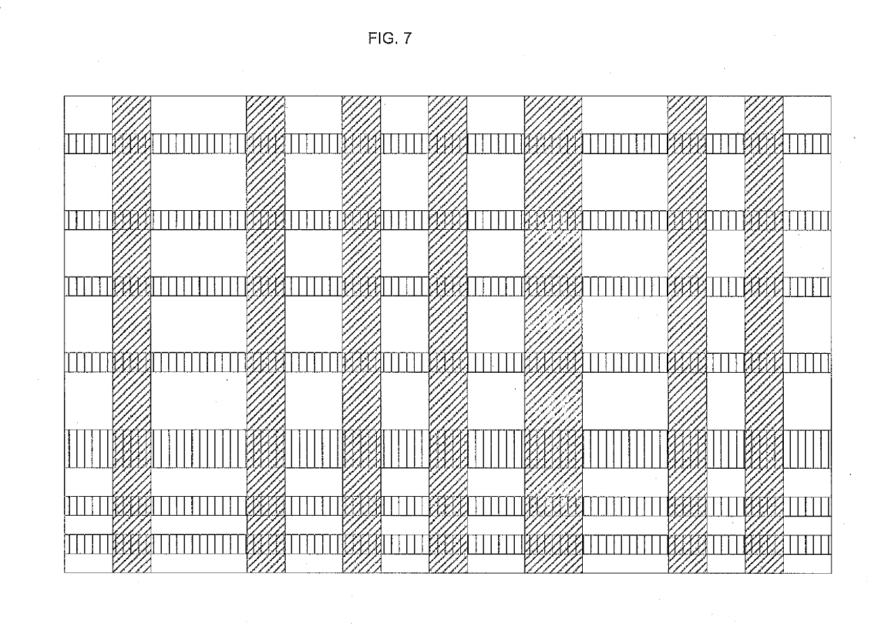

As an illustration, FIGS. 6(a)-(f) depict some of many possibilities of V₂(A²,B²) under different arrangements of A² (shaded rectangles) and B² (unshaded rectangles). FIGS. 6(e)-(f) represent two extreme cases. In particular, FIG. 6(e) shows that V₂(A²,B²) becomes empty as A² completely encloses B². And FIG. 6(f) indicates that V₂(A²,B²) can yield many distinct 2-box partitions.

Let A^{d}=(I₁, . . . , I_{d})ₐ and B^{d}=(I₁, . . . , I_{d})_{b} be two d-boxes. Let [symbol] ᵢ₌₁^{k}∩Iᵢ(A^{d},B^{d}) be denoted by ∩Vₖ(A^{d},B^{d}). For all positive integers 2≦k≦d,

$${V}_{k} ( {A}^{d} , {B}^{d} ) = ( \begin{matrix}{V}_{k - 1} ( {A}^{d} , {B}^{d} ) ⊗ \\ {I}_{k} ( {B}^{d} )\end{matrix} ) ⊕ ( \begin{matrix}⋂ {V}_{k - 1} ( {A}^{d} , {B}^{d} ) ⊗ \\ ( \begin{matrix}{I}_{k} ( {B}^{d} ) ⊖ \\ ⋂ {I}_{k} ( {A}^{d} , {B}^{d} )\end{matrix} )\end{matrix} ) \qquad ( 12 )$$

with the initial value V₁(A^{d},B^{d})=I₁(B^{d})θ∩I₁(A^{d},B^{d}). This results in the following equation:

$${V}_{k} = {⊗}_{i = 1}^{k} {I}_{i} ( {ℬ}^{d} ) ⊖ {⊗}_{i = 1}^{k} ⋂ {I}_{i} = {⊗}_{i = 1}^{k} {I}_{i} ( {ℬ}^{d} ) ⊖ ⋂ {V}_{k} \qquad ( 13 )$$

Observe that V₁(A^{d},B^{d})=I₁(B^{d})θ∩I₁(A^{d},B^{d}) is the seed value for the recurrence relation (2≦k≦d). To establish the recurrence relation, consider

$${V}_{k} ⊗ ( {I}_{k + 1} ( {ℬ}^{d} ) ⊕ ⋂ {I}_{k + 1} ) = {V}_{k + 1} ⊖ ⋂ {V}_{k + 1} ⊖ {I}_{k + 1} ( {ℬ}^{d} ) ⊗ ⋂ {V}_{k} ⊕ {⊗}_{i = 1}^{k} {I}_{i} ( {ℬ}^{d} ) ⊗ ⋂ {I}_{k + 1} \qquad ( 14 )$$

A simplified version of this equation yields:

$${V}_{k} ⊗ ( {I}_{k + 1} ( {ℬ}^{d} ) ⊕ ⋂ {I}_{k + 1} ) = {V}_{k + 1} ⊖ {I}_{k + 1} ( {ℬ}^{d} ) ⊗ ⋂ {V}_{k} ⊕ {⊗}_{i = 1}^{k} {I}_{i} ( {ℬ}^{d} ) ⊗ ⋂ {I}_{k + 1} \qquad ( 15 )$$

Combining equations 13 and 15 yields:

$$\begin{matrix}{V}_{k + 1} = {V}_{k} ⊗ {I}_{k + 1} ( {ℬ}^{d} ) ⊕ {I}_{k + 1} ( {ℬ}^{d} ) ⊗ ⋂ {V}_{k} ⊖ \\ {⊗}_{i = 1}^{k} {I}_{i} ( {ℬ}^{d} ) ⊗ ⋂ {I}_{k + 1} ) ⊕ {V}_{k} ⊗ ⋂ {I}_{k + 1} \\ = {V}_{k} ⊗ {I}_{k + 1} ( {ℬ}^{d} ) ⊕ ⋂ {V}_{k} ⊗ ( {I}_{k + 1} ( {ℬ}^{d} ) ⊖ ⋂ {I}_{k + 1} )\end{matrix} \qquad ( 16 )$$

Lemma 3. For all positive integers 1≦k≦d, Vₖ(A^{d},B^{d}) and ∩Vₖ(A^{d},B^{d}) are disjoint. This may be proven by:

$${V}_{k} ( {𝒜}^{d} , {ℬ}^{d} ) ⋂ ⋂ {V}_{k} ( {𝒜}^{d} , {ℬ}^{d} ) = ( {⊗}_{i = 1}^{k} {I}_{i} ( {ℬ}^{d} ) ⊖ ⋂ {V}_{k} ( {𝒜}^{d} , {ℬ}^{d} ) ) ⋂ ( ⋂ {V}_{k} ( {𝒜}^{d} , {ℬ}^{d} ) ) = ∅ \qquad ( 17 )$$

Furthermore, a d-box partition of V_{d}(A^{d},B^{d}) is expressed as follows:

$${⊕}_{i = 1}^{d} ( ⋂ {V}_{d - i} ⊗ {V}_{1} ( {I}_{d - i + 1} ( {𝒜}^{d} ) , {I}_{d - i + 1} ( {ℬ}^{d} ) ) ⊗ {⊗}_{k = d - i + 2}^{d} {I}_{k} ( {ℬ}^{d} ) ) \qquad ( 18 )$$

This may be proven as follows. V₁(I_{d}(A^{d}),I_{d}(B^{d}))≡I_{d}(B_{d})θ∩I_{d}. V_{d}(A^{d},B^{d}) is partitioned into two disjoint parts:

$$\overbrace{{V}_{d}}^{d} = \overbrace{{V}_{d - 1}}^{d - 1} ⊗ \overbrace{{I}_{d} ( {ℬ}^{d} )}^{1} ⊕ \overbrace{⋂ {V}_{d - 1}}^{d - 1} ⊗ \overbrace{( {I}_{d} ( {ℬ}^{d} ) ⊖ ⋂ {I}_{d} )}^{1} \qquad ( 19 )$$

This implies that ∩V_{d-1} [symbol] V₁(I_{d}(A^{d}),I_{d}(B^{d})) and V_{d-1} [symbol] I_{d}(B^{d}) are disjoint since ∩V_{d-1}∩V_{d-1}=0 based on Lemma 3. Turn next to V_{d-1} [symbol] I_{d}(B^{d}). Based on the recurrence relation set forth above, this term can be further partitioned into two disjoint parts:

$${V}_{d - 1} ⊗ {I}_{d} ( {ℬ}^{d} ) = {V}_{d - 2} ⊗ {I}_{d - 1} ( {ℬ}^{d} ) ⊗ {I}_{d} ( {ℬ}^{d} ) ⊕ \overbrace{⋂ {V}_{d - 2}}^{d - 2} ⊗ \overbrace{{V}_{1} ( {I}_{d - 1} ( {𝒜}^{d} ) , {I}_{d - 1} ( {ℬ}^{d} ) )}^{1} ⊗ \overbrace{{I}_{d} ( {ℬ}^{d} )}^{1} \qquad ( 20 )$$

Furthermore, it can be inferred that there is no intersection between:

1) ∩V_{d-1} [symbol] V₁(I_{d}(A^{d}),I_{d}(B^{d})) (21)

2) ∩V_{d-2} [symbol] V₁(I_{d-1}(A^{d}),I_{d-1}(B^{d})) [symbol] I_{d}(B^{d}) (22)

because ∩V_{d-1} [symbol] V₁(I_{d}(A^{d}),I_{d}(B^{d}))∩V_{d-1} [symbol] I_{d}(B^{d})=0. This process is repeated until the initial value for the recurrence relation is reached.

$${V}_{2} ⊗ {⊗}_{i = 3}^{d} {I}_{i} ( {ℬ}^{d} ) = ⋂ {V}_{1} ⊗ P ( {I}_{2} ( {𝒜}^{d} ) , {I}_{2} ( {ℬ}^{d} ) ) ⊗ {⊗}_{k = 3}^{d} {I}_{k} ( {ℬ}^{d} ) ⊕ {V}_{1} ⊗ {⊗}_{k = 2}^{d} {I}_{k} ( {ℬ}^{d} ) \qquad ( 23 )$$

Summing up all results gives rise to the following.

$${V}_{d} = {⊕}_{i = 1}^{d} \text{(} ⋂ {V}_{d - 1} ⊗ {V}_{1} ( {I}_{d - i + 1} ( {𝒜}^{d} ) , {I}_{d - i + 1} ( {ℬ}^{d} ) ) ⊗ {⊗}_{k = d - i + 2}^{d} {I}_{k} ( {ℬ}^{d} ) \qquad ( 24 )$$

Note that V₁(I₁(A^{d}),I₁(B^{d}))≡V₁(A^{d},B^{d}). It is shown that d-boxes in equation (24) are disjoint, and hence form a d-box partition of V_{d}(A^{d},B^{d}). This has important implications. For instance, it provides a recursive method of obtaining a d-box partition of V(Aⁿ,Bⁿ). It also offers an efficient piecemeal means for computing the d-box partition, thereby overcoming a significant dimensionality-induced complexity. For instance, identifying a d-box partition of equations (21) and (22) is reduced to identifying an 1-box partition of V₁(I_{d}(A^{d}),I_{d}(B^{d})) and V₁(I_{d-1}(A^{d}),I_{d-1}(B^{d})).

Lemma 4. Let A^{d}=(I₁, . . . , I_{d})ₐ and B^{d}=(I₁, . . . , I_{d})_{b} be two d-dimensional boxes. Let Cᵢ^{d}, . . . , Cᵢ^{m} be a set of d-boxes obtained via equation (18). Then there is no intersection among An, C₁ⁿ, . . . , Cₘⁿ. Thus, it may be proven that:

$$\begin{matrix}{𝒜}^{d} ⋂ {V}_{d} ( {𝒜}^{d} , {ℬ}^{d} ) = {𝒜}^{d} ⋂ ( {ℬ}^{d} ⊖ Δ {V}_{d} ( {𝒜}^{d} , {ℬ}^{d} ) ) \\ = Δ {V}_{d} ( {𝒜}^{d} , {ℬ}^{d} ) ⊖ Δ {V}_{d} ( {A}^{d} , {ℬ}^{d} ) \\ = ∅\end{matrix} \qquad ( 25 )$$

This equation implies that A^{d}∩Cₖ^{d}=0. Since C₁^{d}, . . . , Cₘ^{d} form a d-box partition of V_{d}(A^{d},B^{d}), then Cᵢ^{d}∩Cⱼ^{d}=0 with i≠j. The lemma is thus proved. This leads to the following aspect of the invention. For a given pair of two extended ACL entries aᵢ=(B⁵,S)ᵢ, aⱼ=(B⁵,S)ⱼ (aⱼπaᵢ), the union of aᵢ and ({V₅(Bᵢ⁵,Bⱼ⁵)},S(aⱼ)) is an order-free equivalent to entry pair aᵢ and aⱼ. This may be established by noting that it follows from Lemma 4 that Bᵢ⁵ and V₅(Bᵢ⁵,Bᵢ⁵) are disjoint.

As an illustration, an example from FIGS. 5(a)-(f) may be used to show how to partition Vn(Aⁿ,Bⁿ) into a set of d-boxes in a piecemeal fashion and how to construct the order independent equivalent ACLs for a given order dependent extended ACL pair aᵢ and aⱼ (aⱼ π aᵢ).

TABLE
Piecemeal Computation
Initial setting

| | |
|---|---|
| a₁ = ([4, 7], [4, 7], 0) | a₂ = ([1, 10], [1, 10], 1) |
| A² = ([4, 7], [4, 7]) | B² = ([1, 10][1, 10]) |
| I₁(A²) = I₂(A²) = [4, 7] | I₁(B²) = I₂(B²) = [1, 10] |
| ΔV₀ = Ø | V₀ = Ø |

Computing V₁(A², B²)

| | |
|---|---|
| ΔI₁(A², B²) | [4, 7]∩[1, 10] = [4, 7] |
| I₁(B²)ΘΔI₁(A², B²) | [1, 10]Θ[4, 7] = {[1, 3], [8, 10]} |
| ΔV₁(A², B²) | ΔI(A², B²) = [4, 7] |
| V₁(A², B²) | I₁(B²)ΘΔI₁(A², B²) = {[1, 3], [8, 10]} |

Computing V₂(A², B²)

| | |
|---|---|
| ΔI₂(A², B²) | [4, 7]∩[1, 10] = [4, 7] |
| I₂(B²)ΘΔI₂(A², B²) | [1, 10]Θ[4, 7] = [1, 3], [8, 10] |
| V₁(A², B²) [symbol] I₂(B²) | {[1, 3], [8, 10]} [symbol] [1, 10] = |
| | ([1, 3], [1, 10]), ([8, 10], [1, 10]) |
| ΔV₁(A², B²) [symbol] | [4, 7] [symbol] {[1, 3], [8, 10]} = |
| (I₂(B²)ΘΔI₂(A², B²)) | ([4, 7], [1, 3]), ([4, 7], [8, 10]) |
| ΔV₂(A², B²) | ΔI₁ [symbol] ΔI₂ = ([4, 7], [4, 7]) |
| V₂(A², B²) | ([1, 3], [1, 10]), ([8, 10], [1, 10]) |
| | ([4, 7], [1, 3]), ([4, 7], [8, 10]) |

Computing order independent ACLs

| | |
|---|---|
| a₁, ({V₂(A², B²}, 1) | ([1, 3], [1, 10], 1), ([8, 10], [1, 10], 1) |
| | ([4, 7], [1, 3], 1), ([4, 7], [8, 10], 1) |
| | ([4, 7], [1, 3], 1), ([4, 7], [8, 10], 1) |
| | ([4, 7], [4, 7], 0) |

For a given extended ACL (a₁, . . . , aₙ), one can extend the ACL procedure of FIG. 3 to construct an order independent equivalent. Almost all processes in the procedure of FIG. 3 may be kept intact, except for putting the spinoff into queue T. In the present case, the operation may be as follows: T.put((V₅(a,b)),S(b))). Despite the similarity in the processing flow, the complexity analysis of translating an extended ACL into its order-free equivalent may be much harder because of dimensionality.

A worst-case analysis of the procedure is provided as follows. First an upper bound on the size of the order-free equivalent based on the concept of trellis is given. Then a discussion of the worst-case complexity analysis of the algorithm is provided. The following definition and lemma are provided to facilitate the proof.

Definition 13. For x=(x₁, . . . , xₙ), y=(y₁, . . . , yₙ)εRⁿ++, where Rⁿ++=(0,∞), let x_{[1]}≧ . . . ≧x_{[n]} and y_{[1]}≧ . . . ≧y_{[n]} denote the components of x and y in decreasing order. Then

$$if \{ \begin{matrix}{\sum }_{i = 1}^{k} {x}_{[ i ]} \leq {\sum }_{i = 1}^{k} y [ i ] & 1 \leq k \leq n - 1 \\ {\sum }_{i = 1}^{k} {x}_{[ i ]} = {\sum }_{i = 1}^{k} {y}_{[ i ]} & k = n\end{matrix} \qquad ( 26 )$$

then y majorizes x. And according to lemma 5, if y “majorizes” x, then Πᵢ₌₁ⁿyᵢ≦Πᵢ₌₁ⁿxᵢ. An immediate consequence of this lemma is that Πᵢ₌₁ⁿxᵢ≦ x̅ⁿ, where x̅=Σᵢ₌₁ⁿxᵢ/n since x=(xᵢ, . . . , xₙ) majorizes ( x̅, . . . , x̅).

Theorem: let n be the size of an order dependent extended ACL, then the maximum size of order-free equivalent is bounded by O((n/d)^{d}) where d the number of dimensions (e.g., d=5 for extended ACL). This can be proven based on the notion of trellises. One can construct a d-dimensional trellis overlapped pattern among ACL entries and prove that this overlapped pattern yields the maximum size of the order independent equivalent.

For instance, let nᵢ be the number of disjoint intervals on the i dimensional space and Σᵢ₌₁^{d}nᵢ=n. An order dependent extended ACL can be constructed as follows. For the last n₁ entries, construct the n₁ disjoint intervals on I₁, while assigning the full ranges to I₂, . . . , I_{d}. For last entries from n−(n₁+1) to n−(n₁+n₂), construct the n₂ disjoint intervals on I₂, while assigning the full ranges to I₁, I₃, . . . , I_{d} and so on so forth. Under this setting, the cross-section area of I₁ [symbol] I₂ is partitioned into n₁ piecewise disjoint rectangles, called “slabs,” by vertical lines parallel to the y-axis. Next, each vertical rectangle is partitioned into n2 rectangles, cells, by lines parallel to the x-axis (see FIG. 7). Thus the total number of intersections (“cells”) is n₁×n₂.

By the ACL's hereditary property, each long horizontal shaded rectangle in FIG. 7 is split into n₂+1 disjoint pieces by the n₂ long vertical hatched rectangles. Hence the number of disjoint rectangles (2-boxes) is proportional to n₁(n₂+1)=O(n₁n₂). Thus, the total number of d-box intersections (cells) is Πᵢ₌₁^{d} nᵢ. It follows from lemma 5 that Πᵢ₌₁^{d} nᵢ≦(n/d)^{d} because (n₁, . . . , n_{d}) majorizes (n/d, . . . , n/d). Thus the maximum number of disjoint d-boxes is bounded by O((n/d)^{d}).

A corollary (corollary 2) to this is that the complexity of an extended ACL is bound by O((n/d)^{d-1}). This corollary states that when involving more than one dimension, the complexity of an ACL depends not only on the number of dimensions d but also on the size of ACL n, in a contrast to the one-dimensional case in standard ACLs, the complexity of an ACL is bounded by O(n/d)⁰=O(1). This shows that complexity analysis of standard ACL in lemma 2 is a special case of this corollary where only one dimension is involved.

Next, it will be shown how to employ the framework to address some fundamental ACL problems, including efficient determination of semantic differences among ACLs, accurate identification of redundant rules, and quantitative evaluation of the impact of order-dependency on each entry in an ACL.

In one scenario, a comprehensive experimental study was conducted based on hundreds of extended ACLs gathered from a large enterprise network.

Definition 14. Let m be the size of order-free ACL equivalent A, aᵢ=(B^{d},S)ᵢ, 1≦i≦M. Let |Iₖ(B^{d})|ᵢ and 1≦k≦d be the kth interval length of aᵢ and S(aᵢ) be the classification status. The positive/negative volumes of that ACL are as follows:

$$\begin{matrix}{V}_{p} ( 𝒜 ) = {\sum }_{i = 1}^{m} {\prod }_{k = 1}^{d} {\vert {I}_{k} ( {ℬ}^{d} ) \vert}_{i} , if 𝒮 ( {a}_{i} ) = 1 & ( 27 ) \\ {V}_{n} ( 𝒜 ) = {\sum }_{i = 1}^{m} {\prod }_{k = 1}^{d} {\vert {I}_{k} ( {ℬ}^{d} ) \vert}_{i} , if 𝒮 ( {a}_{i} ) = 0 & ( 28 )\end{matrix}$$

where the subscripts p and n denote the positive/negative volumes, respectively. Furthermore, let I be an interval, and I^{L} and I^{R} be the left end and right end points of the interval I. Then the volume based hash function is defined as:

$$\begin{matrix}{H}_{p} ( 𝒜 ) = {\sum }_{i = 1}^{m} {\prod }_{k = 1}^{d} {{I}_{k}^{R} ( {ℬ}^{d} )}^{2} - {( {I}_{k}^{L} ( {ℬ}^{d} ) - 1 )}^{2} , if 𝒮 ( {a}_{i} ) = 1 & ( 29 ) \\ {H}_{n} ( 𝒜 ) = {\sum }_{i = 1}^{m} {\prod }_{k = 1}^{d} {{I}_{k}^{R} ( {ℬ}^{d} )}^{2} - {( {I}_{k}^{L} ( {ℬ}^{d} ) - 1 )}^{2} , if 𝒮 ( {a}_{i} ) = 0 & ( 30 )\end{matrix}$$

In accordance with an aspect of the invention, one step is to choose easily computable metrics. Then one may use these metrics to measure ACLs and compare the semantic difference in ACLs. The notion of the positive and negative volume of an ACL was introduced in definition 14 above.

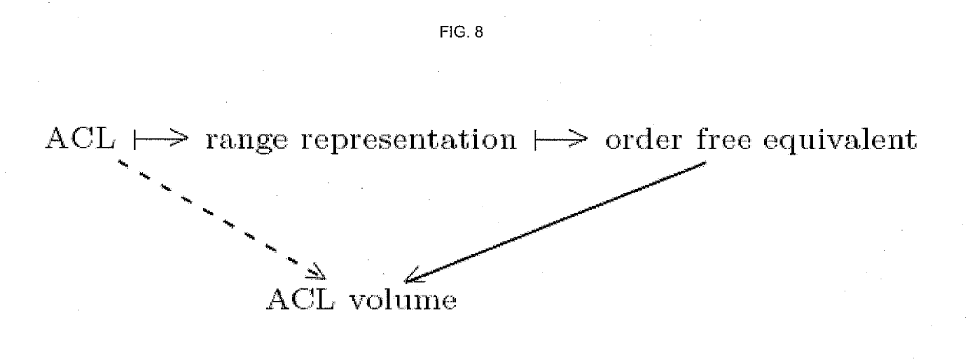

A prerequisite of volume calculation is the equivalency between order-dependent ACL and order-free equivalent illustrated in the diagram of FIG. 8. It should be noted that the volume calculation of the union of d-boxes is closely associated with Klee's measure problem.

The volume determination process herein exploits the fact that d-boxes are disjoint. Hence the total volume of an ACL may be obtained by summing up the volume of each individual d-box. Thus, according to one aspect of the invention, the computational complexity is reduced to O(nd).

Piecemeal construction as set forth above allows one to build up a d-box partition recursively by gluing together the projected results on each dimension according to a given dimension ordering. Different dimension ordering for piecemeal construction may result in a different d-box partition. For example, FIG. 5(c) corresponds to the 2-box (rectangle) partition based on the x-y dimension ordering whereas FIG. 5(b) represents the 2-box (rectangle) partition from the y-x dimension ordering. There exist 5!=120 distinctly different d-box partitions for a 5-dimensional extended ACL. Once the dimension ordering is fixed, a d-box partition can be obtained uniquely.

The volume of an ACL defined in accordance with equations 27 and 28 has a particular geometric interpretation. In particular, it denotes the amount of d-dimension space it occupies and is invariant with the dimension ordering in the d-box partition. A small positive volume of an ACL implies a tighter control on traffic flow. The ACL volume appears to be an ideal quantitative security metric for enterprise networks. However, ACL volume constitutes an important condition for the semantic equivalence or relatedness of two ACLs. Thus, ACL volume may not be an ideal metric for discerning the semantic difference among ACLs because the semantic meaning of an ACL not only relies on its volume but also its position in d-dimensional space.

In view of this, the volume-based hash function introduced above in equations (29)-(30) may be employed as an index for efficiently discerning whether ACLs are semantically equivalent. Hₚ(A) takes an order-free ACL as the input parameter and generates the hashed value that reflects the volume and position of the ACL. Another aspect of the invention focuses on minimizing the chance of collision, rather than on dictionary operations of a hash function such as INSERT, SEARCH, and DELETE. To make the hash function sensitive to both the volume and position, equations (29)-(30) are constructed as follows:

$$\begin{matrix}{{I}_{k}^{R} ( {ℬ}^{d} )}^{2} - {( {I}_{k}^{L} ( {ℬ}^{d} ) - 1 )}^{2} = ( {I}_{k}^{R} ( {ℬ}^{d} ) - {I}_{k}^{L} ( {ℬ}^{d} ) + 1 ) \\ ( {I}_{k}^{R} ( {ℬ}^{d} ) + {I}_{k}^{L} ( {ℬ}^{d} ) - 1 ) \\ = \overbrace{\vert {I}_{k} ( {ℬ}^{d} ) \vert}^{volume} \times \overbrace{( {I}_{k}^{R} ( {ℬ}^{d} ) + {I}_{k}^{L} ( {ℬ}^{d} ) - 1 )}^{position}\end{matrix} \qquad ( 31 )$$

Each element in equations (29)-(30) is a product of two conceptually different sub-elements, namely volume and position as shown in equation (31). Although the hash-based function may not guarantee 100% accuracy in discerning the semantic equivalence among ACLs in theory, in practice it is more than accurate enough to distinguish the subtle semantic differences among ACLs. One very attractive feature of this approach is its computational efficiency. It takes O(nd) time to compute the hash value for an order-free equivalent of size of n, and takes O(1) for comparing whether two ACLs are semantically identical.

Based on a multidimensional interval tree structure, the optimal run-time overhead of deterministic algorithm for determining whether two sets of d-boxes are identical is reported to be O(n² log^{d} n). By building on top of such a framework, it can be shown how to support redundancy detection and quantitative evaluation of the impact of order-dependency on each entry in a given ACL.

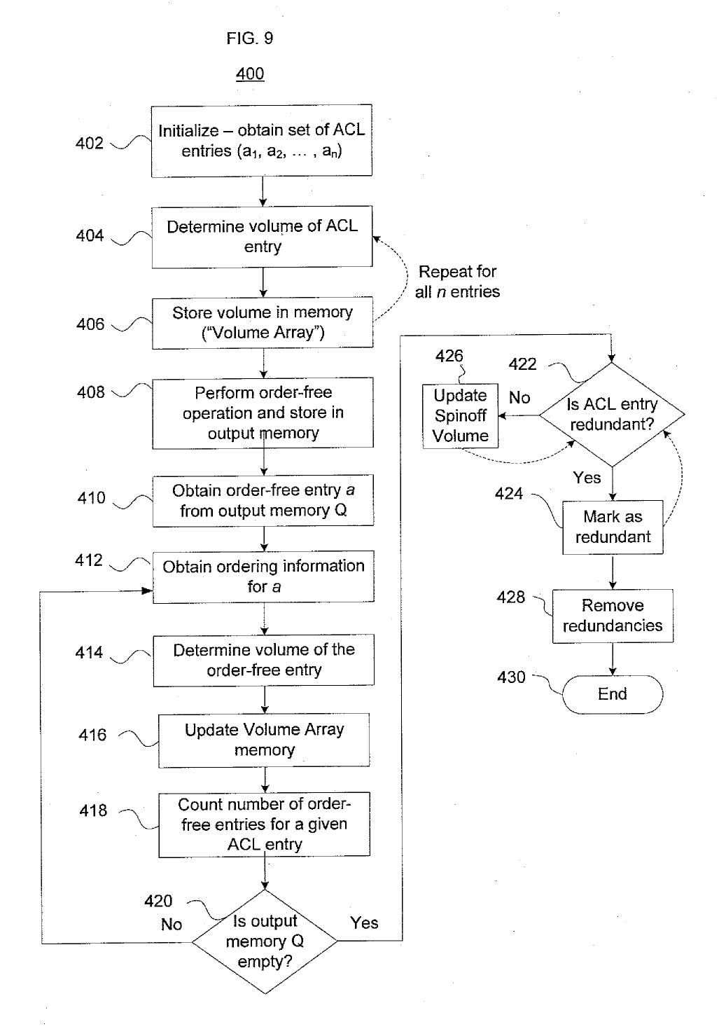

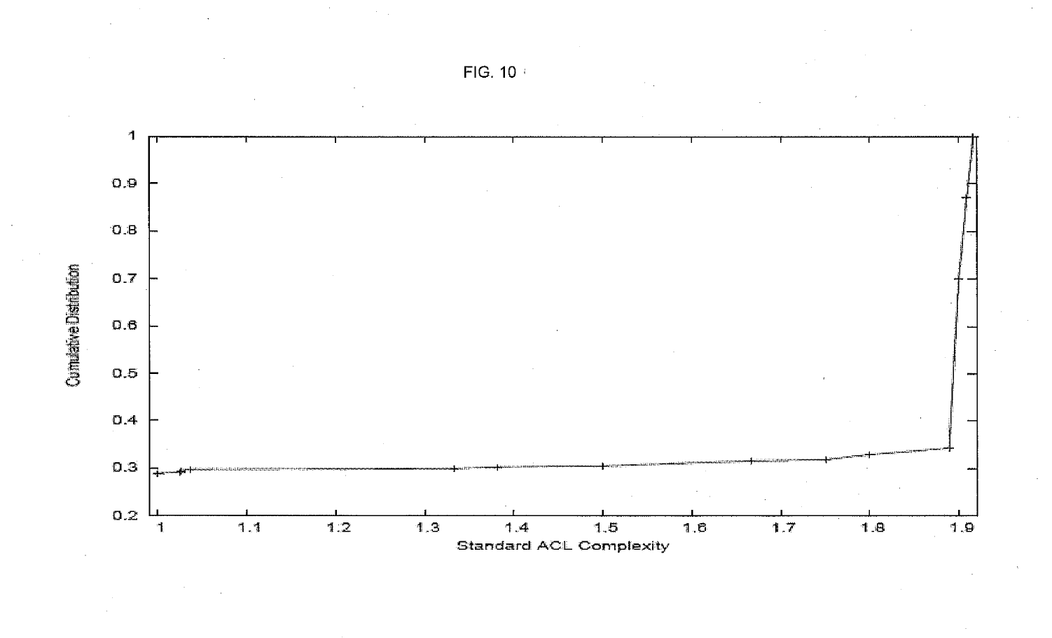

FIG. 9 illustrates a process 400 for detecting redundancy in a given ACL. The process may initialize as shown in block 402 by obtaining the set of ACL rules. At block 404, the volume of a first ACL entry is determined. Spinoff rules mean that the rules are in order-free equivalents. Spinoff volume means the product of the length of each dimension. The volume of an ACL means the summation of all spinoff (order-free) rules in order-free equivalent). The volume is stored in memory at block 406. The memory may be configured as an array (e.g., a “Volume Array”). For instance an object may be constructed for entry a₁ and its ranking i and storing this object into a queue (e.g., a LIFO queue) F. This is repeated for all n ACL rules. The Volume Array is used to store spinoff entries, and is employed when determining the volume of an ACL.

As shown in block 408, an order-free operation is performed. This function uses the queue F as its input and a queue Q as its output. Q will contain the corresponding order-free equivalent a. The order-free operation may follow the process set forth in FIG. 3.

At block 410, the order-free entry a is removed from the output queue Q (e.g., a LIFO queue). Then at block 412, the ordering information (e.g., sequence number) of the order-free entry is obtained. At block 414, the volume of this order-free entry is determined (e.g., “spinoff volume”), and at block 416 the Volume Array is updated in the corresponding entry. Then, at block 418, the number of order-free rules with respect to a given ACL entry are counted. If the output queue Q is not empty when checked at block 420, then the process returns to block 412 where the next order-free entry is processed.

Next, the degree of alteration for each ACL entry is computed. For instance, the scope contraction ratio D(A,aᵢ) for each ACL entry may be computed. At block 422, it is checked whether an entry is redundant. For instance, for a given entry i, the process may evaluate whether the spinoff of is zero (e.g., spinoff[i]==0). If so, then that entry is marked as redundant at block 424. If it is not redundant, then the spinoff volume of that entry (i) is updated (e.g., spinoffvolume[i]=spinoffvolume[i]/volume [i]) in block 426. The total spinoff volume is the summation of all spinoff entries, which may be negative or positive depending upon the deny/permit status of an entry. The volume means the product of intervals in different dimensions. If there are any other entries remaining, the process returns to block 422 as shown by the dashed lines. Redundant entries may be removed as shown in block 428, resulting in a modified ACL. The process terminates at block 430.

In one scenario in accordance with aspects of the invention, a set of standard ACLs was collected from an enterprise network and evaluated to uncover abnormalities hidden in the ACLs and to discern semantic differences among ACLs. Information concerning the set of standard ACLs is provided in the table below.

TABLE
Statistics for Standard ACLs

| | | | |
|---|---|---|---|
| min | max | mean | standard deviation |

Complexity of Standard ACL: Ψ(A)

| | | | |
|---|---|---|---|
| 1 | 1.917 | 1.628 | 0.412 |

Redundant entries

| | | | |
|---|---|---|---|
| 1 | 9 | 4.4 | 3.96 |

Ratio of redundant size to input size

| | | | |
|---|---|---|---|
| 0.053 | 0.225 | 0.1086 | 0.07 |

1.34% standard ACLs contain redundent entries

The above table shows that among the total of 373 standard ACLs analyzed, 5 contained redundant rules, accounting for roughly 1.34% of the total examined ACLs. This observation strongly suggests a general inclination of network administrators to put more specific rules before more general rules in an ACL, which is viewed as good practice in general. As also shown in the above table, a relatively low percentage 1.34% of ACLs contained redundant rules. This may be attributed to inexperienced network administrators or careless ACL editing.

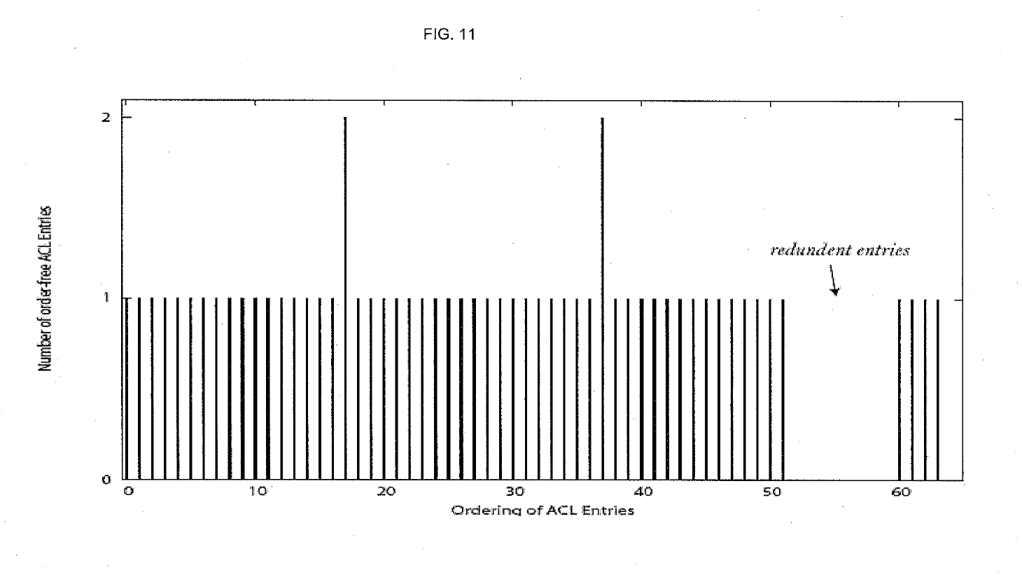

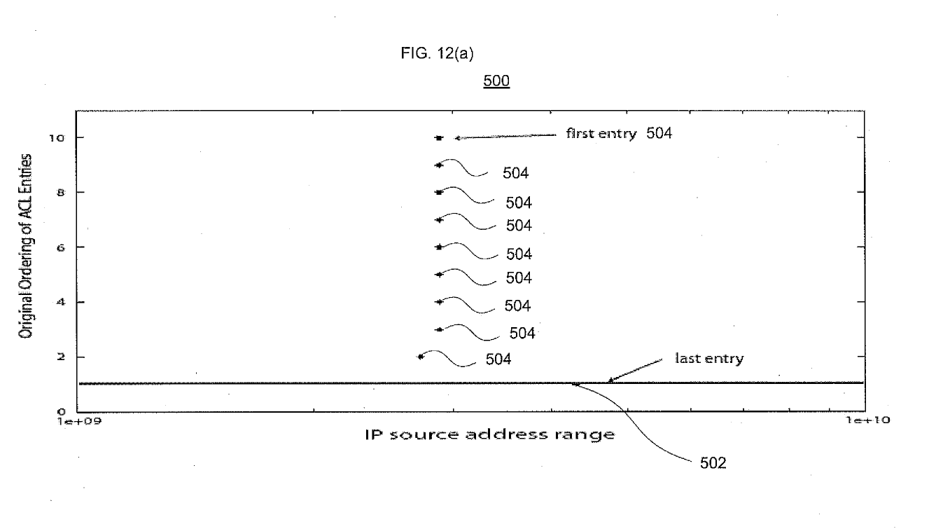

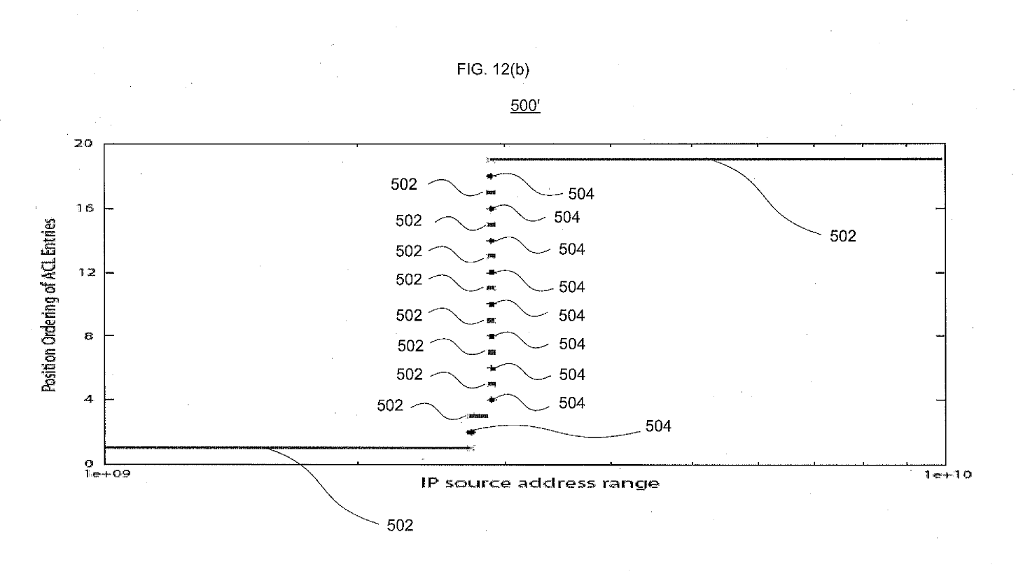

The processes discussed above may be employed not only to translate an order-dependent ACL into an order-free ACL, but also to identify redundant rules during the translation process. For instance, FIG. 11 illustrates ACL rules and the number of order-free ACLs. The x-axis in FIG. 11 represents ACL rules in their original order and the y axis refers to the number of spin-off order-free rules from the original one. It can be seen from FIG. 11 that both the 18th and 38th rules spin-off two order-free rules, while rules 53 through 60 yield an empty order-free entry, implying that the original rules are redundant. Next, an example of translating an existing order dependent ACL into its order-free equivalent is considered. FIGS. 12(a)-(b) plot the scope of each entry in the ACL for both order-dependent and order-free entries. FIG. 12(a) illustrates a plot 500 for the original ordering of ACL entries, while FIG. 12(b) illustrates a plot 500′ for the position ordering of ACL entries. Items 502 in the figures refer to the deny action to be performed on the source IP address range and items 504 denote the permit action. The x-axis in both FIGS. 12(a) and 12(b) represents the source IP address range. The y-axis in FIG. 12(a) refers to the precedence ordering of 10 entries in the ACL. The y-axis in FIG. 12(b) represents the position ordering of 19 order-tree entries.

It can be seen from the graph in FIG. 12(a) that the first nine entries in the ACL allow access a host with a specific IP address, which correspond to 9 distinct points 504 in the source IP address space. The last entry is an explicit deny any statement, which corresponds to a bar 502 covering the entire source IP address. The corresponding order-free ACL of FIG. 12(b) contains 19 entries, namely 9 distinct points 504, 8 small intervals 502 interlacing the consecutive points 504 and 2 long intervals 502 that cover both ends.

To better visualize, in the graph in FIG. 12(b), the interval 502 interlacing two consecutive points 504 is vertically placed between these points. It should be noted that by default there is an implicit deny at the end of every ACL.

Both explicit and implicit denies have the same effect on packet classification, but they differ in their semantic meaning. Such a subtle difference between an implicit deny and an explicit deny can be captured by the volume-based analysis set forth above. It follows from equations (27)-(28) that the positive volume of the ACL in the present example is 9 while the negative volume is 4,294,967,287. However, removing explicit deny entry at the end of the ACL list implies that the ACL list is terminated by an implicit deny entry, which corresponds to the zero negative volume.

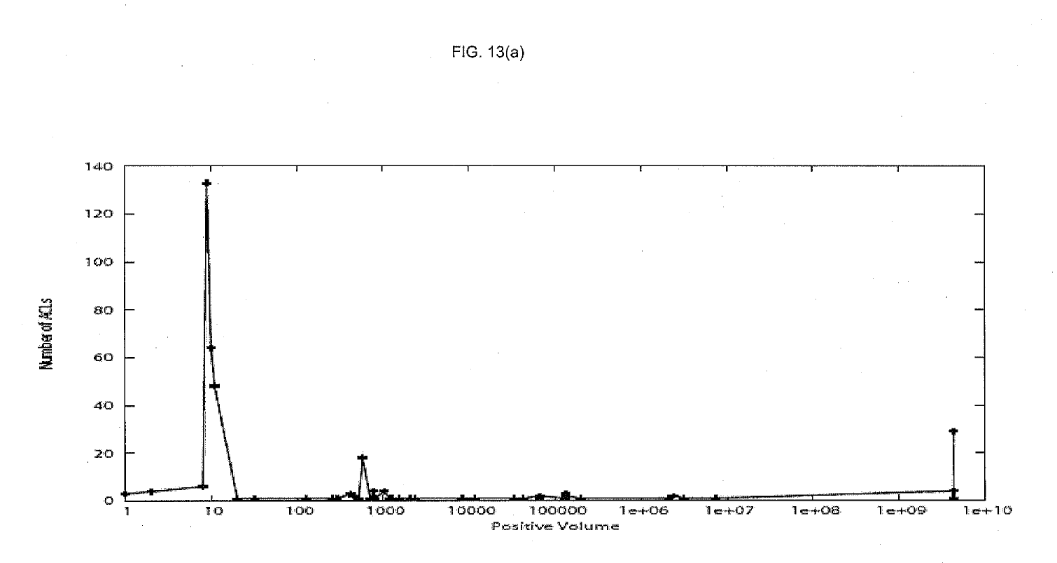

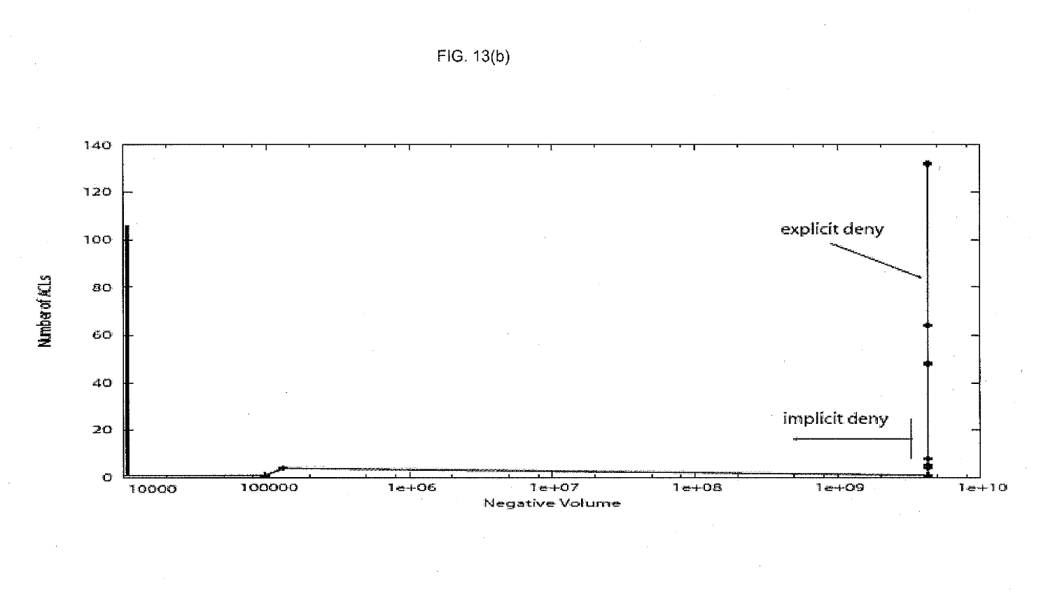

FIGS. 13(a) and (b) illustrate examples of ACL volume distribution. They are plotted with a log-scaled x-axis and show the positive/negative ACL volume distribution constructed from the 373 standard ACLs gathered from a large set of enterprise networks in the present example. FIG. 13(a) shows positive ACL volume and FIG. 13(b) shows negative ACL volume. It can be found that the positive volume distribution has two big peaks at around 10 and 4,294,967,296 in FIG. 13(a). This suggests that ACL rules involving a specific IP address are dominant in the total examined standard ACLs. The negative volume distribution graph of FIG. 13(b) has two peaks at 0 and around 4,294,967,287, which indicates that among the 373 standard ACLs in the example, 108 ACLs use an implicit deny and the remaining ACLs use an explicit deny at the end of ACLs.

In another example, 314 extended ACLs were Analysis showed that among the total of 314 extended ACLs, 33 of these ACLs contain redundant rules, which accounts for 10.5% of total examined ACLs, in sharp contrast to the 1.33% redundant ACLs in standard ACLs discussed above. Among extended ACLs with redundant rules, on average 7 out of 100 rules were redundant, as shown in the following table.

TABLE
Statistics for Extended ACLs

| | | | |
|---|---|---|---|
| min | max | mean | standard deviation |

Complexity of Extended ACLs

| | | | |
|---|---|---|---|
| 1 | 92.884 | 2.367 | 5.638 |

Redundant entries

| | | | |
|---|---|---|---|
| 1 | 118 | 12.21 | 24.81 |

Ratio of redundant size to input size

| | | | |
|---|---|---|---|
| 0.038 | 0.51 | 0.076 | 0.103 |

10.5% extended ACLs containing redundant entries

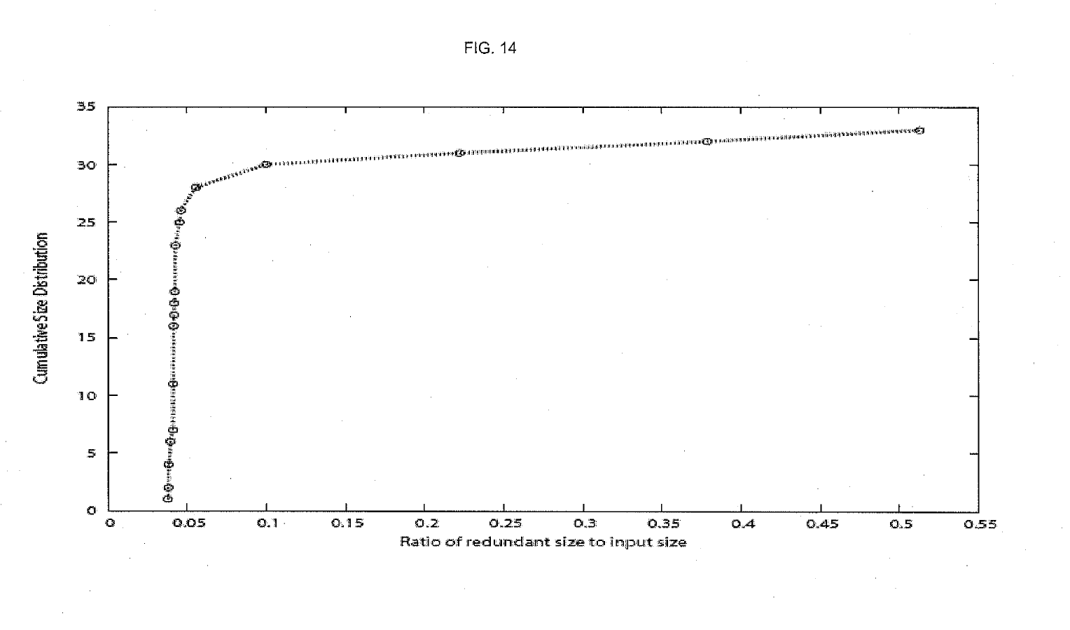

FIG. 14 plots the cumulative distribution of the ratio of redundant size to input size of extended ACLs. The presence of excessive redundant extended ACLs may stem from the dimension-induced complexity in extended ACLs, which severely inhibits our ability to ensure the quality of ACLs and to avoid redundant entries during ACL editing.

The table above presenting statistics for extended ACLs shows that the average and maximum complexity of extended ACLs calculated over 314 examined ACLs is 2.367 and 92.88, respectively. In contrast, the average and maximum complexity of standard ACLs is 1.628 and 1.917. This is in line with the obtained theoretical results. When the dimension of an ACL is more than two, its complexity not only depends on its dimensionality but also depends on its size.

The dimension-induced complexity can be illustrated as follows. One extended ACL had a maximum complexity (92.88) out of the 314 extended ACLs. Aspects of the invention were used to determine that this ACL contained 230 entries, in which 118 entries were redundant. It yielded 10,403 order-free equivalent entries (basic building blocks).

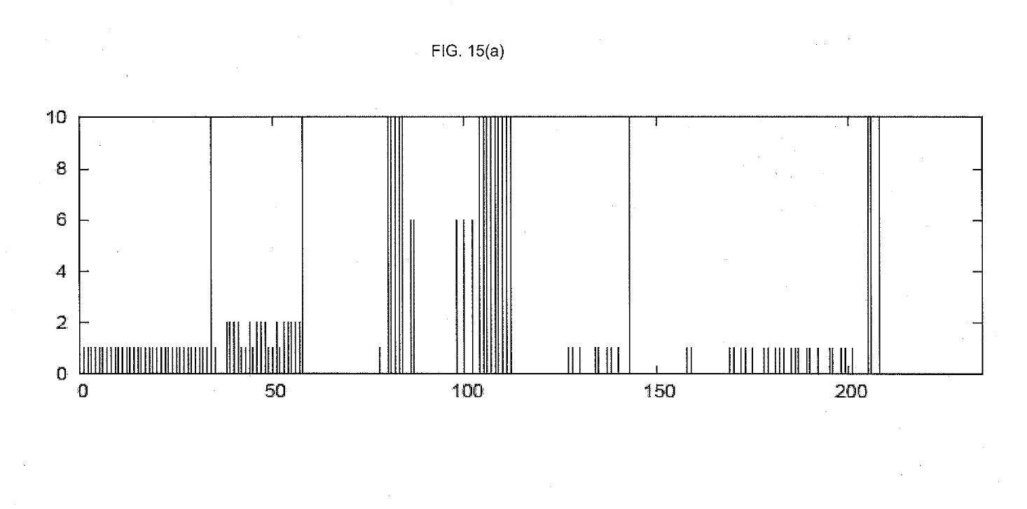

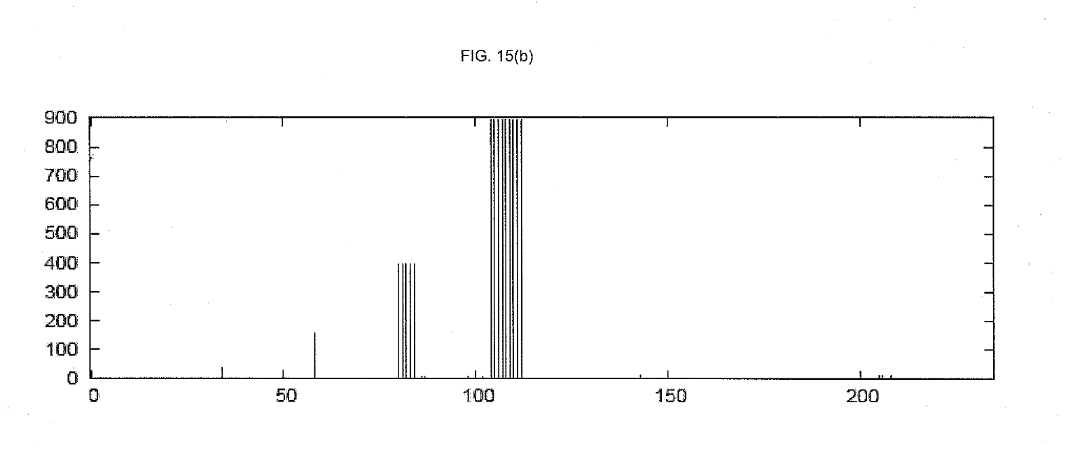

The spinoff entry distribution for this is constructed and plotted in FIGS. 15(a) and 15(b). As shown, the spinoff entry distribution exhibits a highly unevenly distributed pattern. There are up to 895 spinoff order-free rules for each entry 104-112 in the original order. Redundant rules appeared to be randomly distributed within the ACL. And the last 20 rules (from 210 to 230) are found to be redundant (the number of spinoffs is 0), while the first 34 rules turn out to be order-free (the number of spinoffs is one). For better visualization, the same data was plotted using two different y scales. The y scale used in the graph of FIG. 15(a) ranges from 0 to 10, while that used in the graph of FIG. 15(b) ranges from 0 to 900.

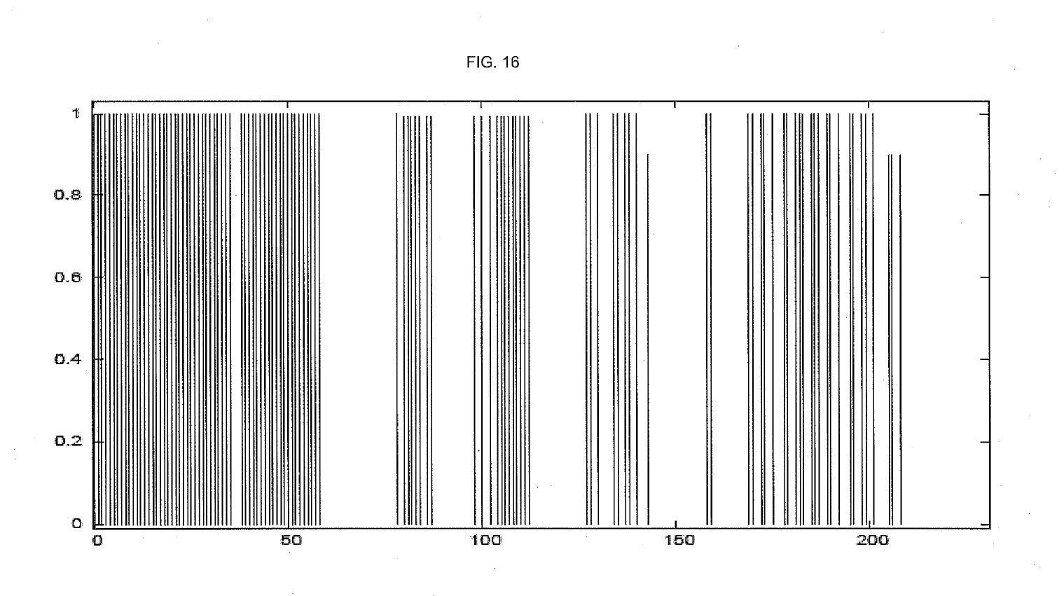

FIG. 16 visualizes the order-dependent impact on each individual entry in the ACL in terms of the order-dependency induced volume contraction D(A,aᵢ). D(A,aᵢ)=1 implies that aᵢ is order-free, while D(A,aᵢ)=0 implies that aᵢ aᵢ is redundant. In accordance with aspects of the invention, it has been discovered that there indeed exist 119 redundant entries in this ACL as shown in FIG. 16.

An experimental study was performed to evaluate the ability of hash-based function to discern semantic change due to modification of ACLs, and to quantify the sensitivity to ACL change in terms of complexity metric. Complexity and volume-based hash values for the original ACL were used as the base-line for comparison. In each run each individual entry in the ACL was deleted and the extent of its impact in comparison to the baselines was quantified.

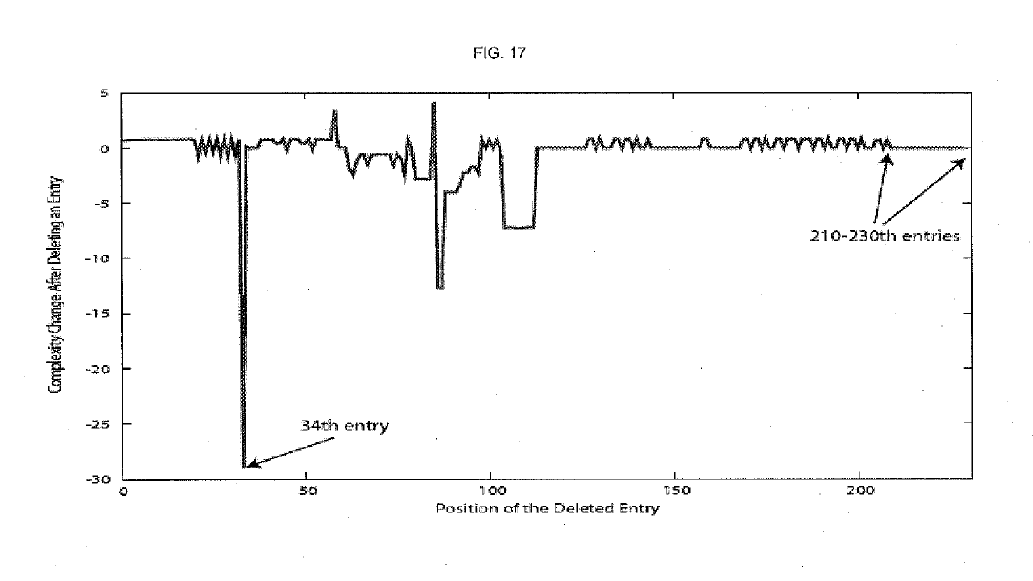

FIG. 17 is a plot showing complexity variation. The x-axis in FIG. 17 represents the original position of an entry being deleted, the y-axis represents the complexity difference after deleting that entry (the complexity with the entry deleted minus the baseline complexity). Several observations can be made. First, deletion of a redundant entry has no impact on the complexity as well as hash value. This is because redundant entries do not contribute to ACL semantics (for example, FIG. 17, entry numbers 210-230). Second, removal of one individual entry may result in a rather big complexity change (for example, FIG. 17, entry number 34). Next, removal of one entry might either increase or decrease the semantic complexity in a pure random fashion. On average over all entries in this example, the complexity change due to one entry removal is reduced by −0.47937, as compared with the baseline complexity. Such complexity change is considered high variance (standard deviation is 2.824158). Furthermore, the volume-based hash function can capture any semantic change induced by removal of any non-redundant entry. Moreover, it can discern the semantic difference between the ith and jth non-redundant entry deletion (i≠j).

Similar to complexity variation analysis, verification of the sensitivity of volume-based hash to semantic changes in ACL due to the deletion of an entry can be analyzed. Equation 32 below gives the difference in the positive volume based hash between the ACL with a deleted entry and the original ACL. Similarly, equation 33 gives the negative volume.

HDₚ(A,A′)=(Hₚ(A′)−Hₚ(A)) (32)

HDₙ(A,A′)=(Hₙ(A′)−Hₙ(A)) (32)

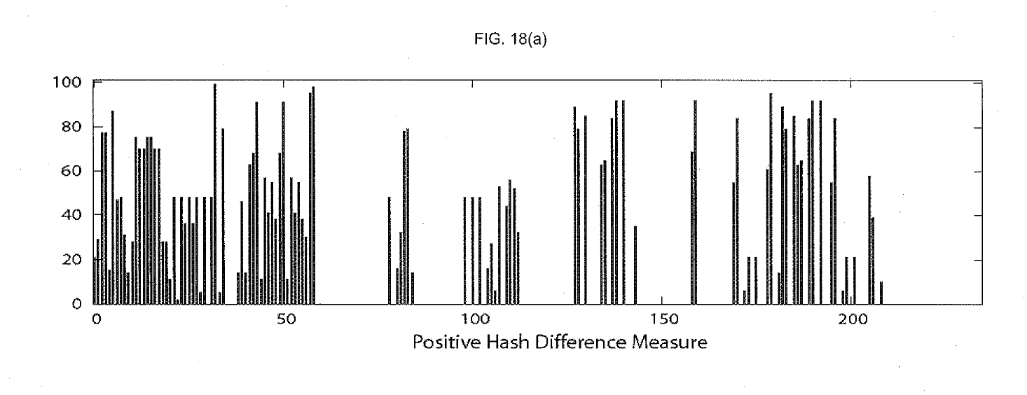

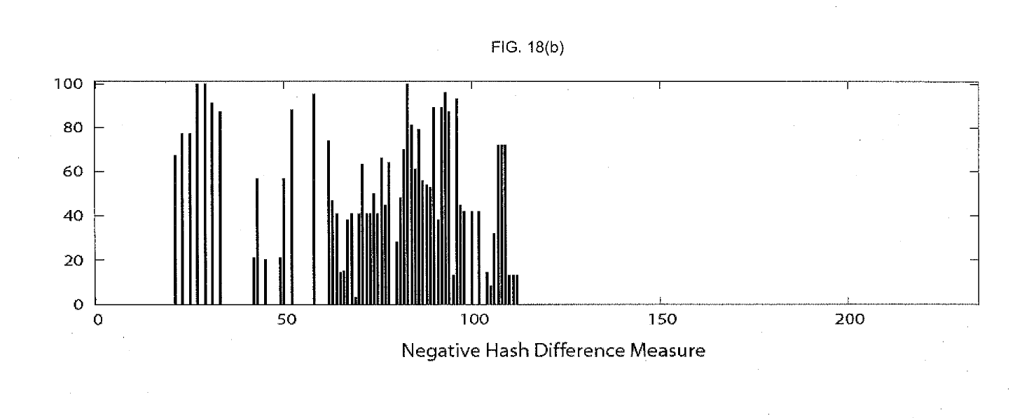

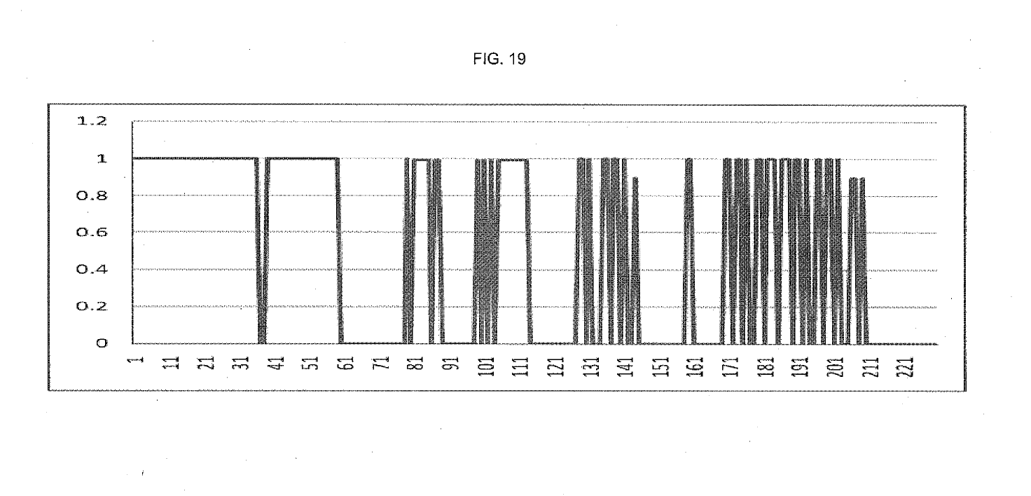

FIGS. 18(a) and 18(b) show that the values do not change when a redundant entry is deleted. However, the values do change for all non-redundant entry deletions. This validates the sensitivity of the volume based hash to semantics of an ACL. And FIG. 19 illustrates a distribution of order-dependent impact on individual ACL entries.

To see the effects of modification on ACLs, an extensive experimental study was conducted with three different perspectives, namely: reordering, deletion, and insertion. To quantify the effect of entry reordering, a random permutation was generated among entries and then the complexity of per-mutated ACL was calculated in comparison to the baseline value. The experiment for random deletion was conducted in a similar fashion.

The experiment study on insertion effect was performed via ACL synthesis. ACL A, which was used as base ACL, contains 230 entries with 118 redundant entries. The complexity of A was measured as 92.88, while ACL B, which is used as additive ACL, contains 256 entries with 97 redundant entries. The complexity of B was measured as 25.96.

In the experimental study, a certain percentage of entries was randomly taken from B and then randomly added into A. Complexity statistics under different permutation, deletion, and insertion rates are presented in the table below.

TABLE
Complexity Statistics Under Permutation,
Deletion and Insertion Rates

| | min | max | mean | std |
|---|---|---|---|---|
| Permutation percentage | | | | |
| 1% | 87.37 | 96.18 | 93.11 | 1.72 |
| 5% | 77.27 | 149.5 | 98.16 | 10.91 |
| 10% | 78.05 | 134.44 | 99.57 | 9.31 |
| 15% | 48.93 | 115.66 | 73.74 | 11.1 |
| Deletion percentage | | | | |
| 1% | 57.18 | 97.05 | 90.42 | 4.68 |
| 5% | 43.91 | 104.01 | 86.01 | 10.06 |
| 10% | 36.19 | 107.23 | 83.86 | 11.35 |
| 15% | 33.81 | 102.07 | 77.38 | 14.31 |
| Insertion percentage | | | | |
| 1% | 92.75 | 98.77 | 93.93 | 1.55 |
| 5% | 92.73 | 107.04 | 98.27 | 2.66 |
| 10% | 90.95 | 241.50 | 122.73 | 26.28 |
| 15% | 93.73 | 230.18 | 126.4 | 27.22 |

base ACL: 230 entries, 118 redundant entries, complexity: 92.88
additive ACL: 256 entries, 97 redundant entries, complexity: 25.96

Each row in the above table was obtained via 200 independent runs. It is shown that generally an increased deletion rate results in a decreased ACL complexity (decreased mean complexity), while an increased insertion rate causes an increased ACL complexity. The complexity of ACLs does not appear very sensitive to permutation rate. Complexity variation (standard deviation) is shown to be correlated highly with deletion and insertion rates. This indicates that the extent of complexity fluctuation is accompanied with an increase of deletion and insertion rates.

The experimental study based on ACLs from an enterprise network indicates the presence of relatively high percentage of redundant rules. It also suggests that ACLs may be highly sensitive to change. Thus, deleting one entry at a particular position in an ACL may significantly alter its semantic meaning, as evidenced by a relative big change in complexity (see FIG. 17). This observation reinforces the need for an efficient process for evaluating the impact of addition addition of new ACL rules and removal of existing ones. It also indicates for an efficient means for automating redundancy detection and resolution. Aspects of the invention as presented herein address these issues.

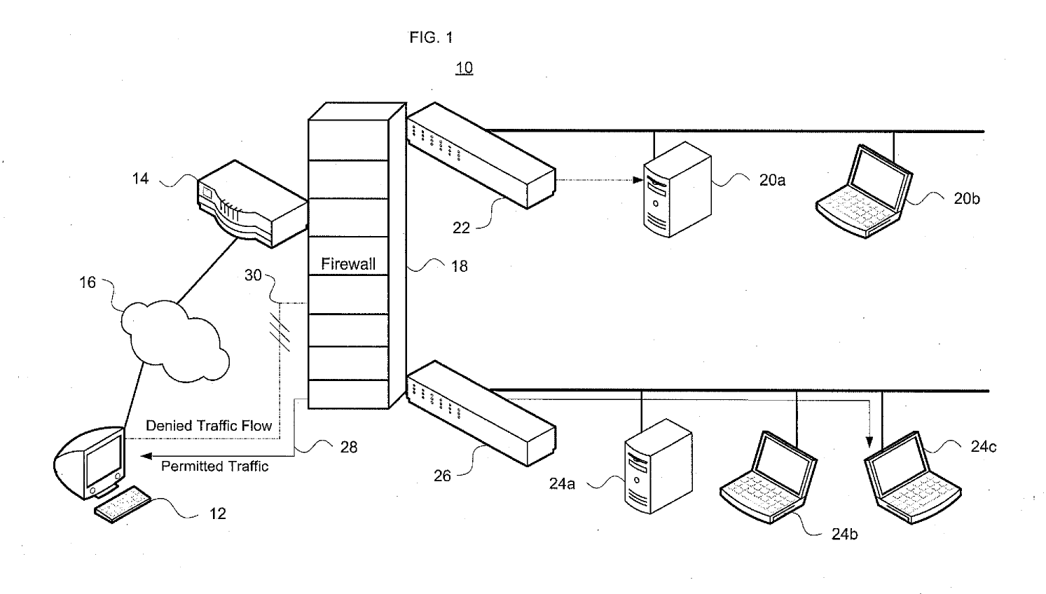

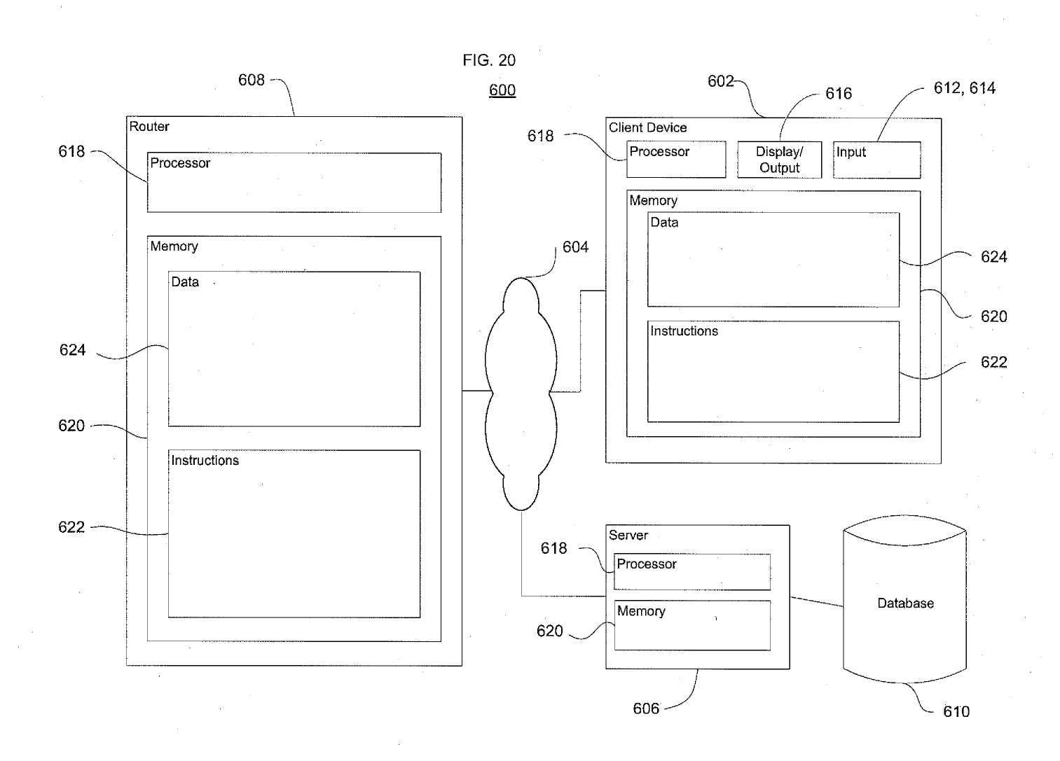

Aspects of the invention may be implemented using a computer network such as shown in FIG. 1 or as shown in FIG. 20. As shown in FIG. 20, computer network 600 may include a client device 602, which may be a desktop or laptop computer, or may be another type of computing device such as a mobile phone, PDA or palmtop computer. The client device 602 may be interconnected via a local or direct connection and/or may be coupled via a communications network 604 such as a Local Area Network (“LAN”), Wide Area Network (“WAN”), the Internet, etc.

The client device 602 may couple to a server 606 via router 608. The server 606 is desirably associated with database 610, which may provide content to the client device 602 if access control list criteria are satisfied. The router 608 may include a firewall (not shown) and maintain an ACL therein.

Each device may include, for example, one or more hardware-based processing devices and may have user inputs such as a keyboard 612 and mouse 614 and/or various other types of input devices such as pen-inputs, joysticks, buttons, touch screens, etc. Display 616 may include, for instance, a CRT, LCD, plasma screen monitor, TV, projector, etc.

The user device 602, server 606 and router 608 may contain at least one processor, memory and other components typically present in a computer. As shown, the router 608 includes a processor 618 and memory 620. Components such as a transceiver, power supply and the like are not shown in any of the devices of FIG. 20.

Memory 620 stores information accessible by the processor 618, including instructions 622 that may be executed by the processor 618 and data 624 that may be retrieved, manipulated or stored by the processor. The firewall may be implemented by the router 608, where the ACL(s) is stored in memory 620. The memory 620 may be of any type capable of storing information accessible by the processor, such as a hard-drive, ROM, RAM, CD-ROM, flash memories, write-capable or read-only memories.

The processor 618 may comprise any number of well known processors, such as processors from Intel Corporation. Alternatively, the processor may be a dedicated controller for executing operations, such as an ASIC.

The instructions 622 may comprise any set of instructions to be executed directly (such as machine code) or indirectly (such as scripts) by the processor. In that regard, the terms “instructions,” “steps” and “programs” may be used interchangeably herein. The instructions may be stored in any computer language or format, such as in object code or modules of source code. The functions, methods and routines of instructions in accordance with the present invention are explained in more detail below.

Data 624 may be retrieved, stored or modified by processor 618 in accordance with the instructions 622. The data may be stored as a collection of data. For instance, although the invention is not limited by any particular data structure, the data may be stored in computer registers, in a relational database as a table having a plurality of different fields and records. In one example, the memory 620 may include one or more stacks or queues for storing the data. In one example, the stacks/queues are configured as LIFOs.

The data may also be formatted in any computer readable format. Moreover, the data may include any information sufficient to identify the relevant information, such as descriptive text, proprietary codes, pointers, references to data stored in other memories (including other network locations) or information which is used by a function to calculate the relevant data.

Although the processor 618 and memory 620 are functionally illustrated in FIG. 20 as being within the same block, it will be understood that the processor and memory may actually comprise multiple processors and memories that may or may not be stored within the same physical housing or location. For example, some or all of the instructions and data may be stored on a removable CD-ROM or other recording medium and others within a read-only computer chip. Some or all of the instructions and data may be stored in a location physically remote from, yet still accessible by, the processor 618. Similarly, the processor 618 may actually comprise a collection of processors which may or may not operate in parallel. Data may be distributed and stored across multiple memories 620 such as hard drives or the like.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims.

While certain processes and operations have been shown in certain orders, it should be understood that they may be performed in different orders and/or in parallel with other operations unless expressly stated to the contrary.

1. A method of processing access control lists in a computer network, the method comprising:
obtaining a first access control list and storing it in memory;
generating an order-free equivalent for the first access control list, the order-free equivalent comprising a plurality of multidimensional rules for permitting or denying access to resources in the computer network; and
using the order-free equivalent to determine whether the first access control list is equivalent to a second access control list.

2. The method of claim 1, wherein the first access control list includes a plurality of entries, and the method further comprises:
selecting first and second ones of the plurality of entries, the first entry having higher precedence in the first access control list than the second entry;
determining whether the first entry completely encloses the second entry, and if the first entry complete encloses the second entry then the second entry is identified as being redundant, and if the first entry does not completely enclose the second entry then generating a spinoff of the second entry;
storing any spinoffs of the second entry in memory; and
repeating the selecting, the determining and the storing until all of the entries in the first access control list have been processed and the spinoffs form at least part of an order-free equivalent of the first access control list.

3. The method of claim 2, further comprising creating a modified access control list that removes all redundant rules.

4. The method of claim 2, wherein each spinoff includes at least one interval and a classification status.

5. The method of claim 4, wherein the at least one interval represents at least one of an address or a port for the computer network.

6. The method of claim 1, further comprising:
determining a volume of the first access control list based on the generated order-free equivalent; and
wherein using the order-free equivalent to determine whether the first access control list is equivalent to the second access control list comprises comparing the volume of the first access control list to a volume of the second access control list to identify any semantic difference between the first and second access control lists.

7. The method of claim 6, wherein determining the volume is based on a permit or deny classification status for each access control rules.

8. The method of claim 6, wherein determining the volume includes calculating a volume-based hash function of the order-free equivalent of the first access control list.

9. An apparatus for processing access control lists in a computer network, the apparatus comprising:
memory for storing information of a plurality of access control lists; and
processor means for obtaining a first access control list from among a set of access control lists and storing it in the memory, for generating an order-free equivalent for the first access control list, the order-free equivalent comprising a plurality of multidimensional entries for permitting or denying access to resources in the computer network, and for network, and for using the order-free equivalent to determine whether the first access control list is equivalent to a second access control list.

10. The apparatus of claim 9, wherein the first access control list includes a plurality of entries, and the processor means is configured to:
select first and second ones of the plurality of entries, the first entry having higher precedence in the first access control list than the second entry;
determine whether the first entry completely encloses the second entry, and if the first entry complete encloses the second entry then the second entry is identified as being redundant, and if the first entry does not completely enclose the second entry then generating a spinoff of the second entry;
store any spinoffs of the second entry in the memory; and
repeat the selecting, the determining and the storing until all of the entries in the first access control list have been processed and the spinoffs form at least part of an order-free equivalent of the first access control list.

11. The apparatus of claim 10, wherein the processor means is further configured to create a modified access control list that omits all redundant entries.

12. The apparatus of claim 10, wherein each spinoff includes at least one interval and a classification status.

13. The apparatus of claim 12, wherein the at least one interval represents at least one of an address or a port for the computer network.

14. The apparatus of claim 9, the processor means being configured to determine a volume of the first access control list, wherein the order-free equivalent is used to determine whether the first access control list is equivalent to the second access control list by comparing the volume of the first access control list to a volume of the second access control list to identify any semantic difference between the first and second access control lists.

15. The apparatus of claim 14, wherein determining the volume is based on a permit or deny classification status for each access control list.

16. The apparatus of claim 14, wherein determining the volume includes calculating a volume-based hash function of the order-free equivalent of the first access control list.
